(19) United States
(12) Patent Application Publication
(10) Pub. No.: US 2026/0190086 A1
(43) Pub. Date: Jul. 2, 2026

(54) METHOD AND APPARATUS FOR RESOURCE HANDLING OF INTERMEDIATE NODE IN A WIRELESS COMMUNICATION SYSTEM

(71) Applicant: ASUS Technology Licensing Inc., Taipei City (TW)

(72) Inventors: Ming-Che Li, Taipei City (TW); Wei-Han Lai, Taipei City (TW); Yu-Hsuan Guo, Taipei City (TW); Meng-Hui Ou, Taipei City (TW); Yi-Hsuan Huang, Taipei City (TW)

(21) Appl. No.: 19/438,450

(22) Filed: Dec. 31, 2025

Related U.S. Application Data
(60) Provisional application No. 63/741,408, filed on Jan. 2, 2025.

(51) Int. Cl. H04W 72/044; H04B 7/06; H04L 1/1812; H04W 72/1268; H04W 72/231; H04W 74/0833

(52) U.S. Cl. CPC H04W 72/044; H04B 7/0626; H04L 1/1812; H04W 72/1268; H04W 72/231; H04W 74/0833

(57) ABSTRACT

Methods, systems, and apparatuses are provided for resource handling of intermediate nodes in a wireless communication system, wherein a method of a User Equipment (UE) comprises receiving, from a network node, a resource allocation or configuration for an Ambient Internet of Things (A-IoT) operation or procedure, deriving or determining available resources based on the resource allocation or configuration and one or more specific time occasions, and utilizing the available resources at least for performing the A-IoT operation or procedure.

### CROSS-REFERENCE TO RELATED APPLICATIONS

The present application claims priority to and the benefit of U.S. Provisional Patent Application Ser. No. 63/741,408, filed Jan. 2, 2025, which is hereby fully incorporated herein by reference.

### FIELD

This disclosure generally relates to wireless communication networks and, more particularly, to a method and apparatus for resource handling of intermediary nodes in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for resource handling of (A-IoT) intermediate nodes in a wireless communication system. As such, intermediate User Equipment (UE) (e.g., UE reader) can properly handle resources for Ambient Internet of Things (IoT) readers and Uu interface transmission/reception and the intermediate UE (e.g., UE reader) can report Ambient IoT-related information via resource(s) provided by a network node.

In various embodiments, a method for a UE in a wireless communication system comprises receiving, from a network node, a resource allocation or configuration for an A-IoT operation or procedure, deriving or determining available resources based on the resource allocation or configuration and one or more specific time occasions, and utilizing the available resources at least for performing the A-IoT operation or procedure.

In various embodiments, a method for a UE in a wireless communication system comprises receiving, from a network node, a resource allocation or configuration for an A-IoT operation or procedure, deriving or determining a set of resources based on the resource allocation or configuration, determining a Reader-to-Device (R2D) transmission and/or scheduling of a Device-to-Reader (D2R) transmission within the set of resources, wherein the determined R2D transmission and/or the scheduled D2R transmission shall avoid overlapping with one or more specific time occasions, and performing the R2D transmission and/or reception of the D2R transmission.

In various embodiments, a method for a UE in a wireless communication system comprises receiving, from a network node, a resource allocation or configuration for an A-IoT operation or procedure, deriving or determining a set of resources based on the resource allocation or configuration, utilizing the set of resources at least for performing the A-IoT operation or procedure, and transmitting or indicating, to the network node, a specific message or signaling associated with utilization of the set of resources or associated with the A-IoT operation or procedure.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.2-1: Topology 2, from 3GPP TR 38.848 V18.0.0 (2023-09).

FIG. 6 is a reproduction of FIG. 6.3.1-1 Overall AS procedures between A-IoT device and reader, from 3GPP TR 38.769 V2.0.0 (2024-12).

FIG. 7 is a reproduction of FIG. 6.3.4-1 General framework of slotted-ALOHA for A-IoT random access procedure, from 3GPP TR 38.769 V2.0.0 (2024-12).

FIG. 8 is a reproduction of FIG. 6.4.2-1 Logical system architecture for topology 2, from 3GPP TR 38.769 V2.0.0 (2024-12).

FIG. 9 is a reproduction of FIG. 6.4.2.1.1-1: RRC based solution of Topology 2, from 3GPP TR 38.769 V2.0.0 (2024-12).

FIG. 10 is a reproduction of FIG. 6.5.3.1.1-1: Message flow for A-IoT Inventory in Topology 2—RRC-based solution, from 3GPP TR 38.769 V2.0.0 (2024-12).

FIG. 11 is a reproduction of FIG. 6.5.3.2-1: Message flow for A-IoT Command in Topology 2 (RRC-based solution), from 3GPP TR 38.769 V2.0.0 (2024-12).

FIG. 12 is a flow diagram of a method of a UE in a wireless communication system comprising receiving one or more DL signalings, from a network node, for allocating/scheduling/providing a set of resources, being scheduled/requested/configured to perform a first UL transmission in a first TTI/occasion, and prioritizing to perform either the first UL transmission or the first R2D transmission based on a type of the first UL transmission, in accordance with embodiments of the present invention.

FIG. 13 is a flow diagram of a method of a UE in a wireless communication system comprising receiving one or more DL signalings, from a network node, for allocating/scheduling/providing a set of resources, being scheduled/requested/configured to perform a first UL transmission in a first TTI/occasion, and prioritizing to perform either the first UL transmission or receiving the second D2R transmission based on a type of the first UL transmission, in accordance with embodiments of the present invention.

FIG. 14 is a flow diagram of a method of a UE in a wireless communication system comprising receiving one or more DL signalings, from a network node, for allocating/scheduling/providing a set of resources, triggering/requesting to perform a first operation/procedure or detecting/determining a first condition in a first timing, which is overlapped with the set of resources in time domain, and in response to performing the first operation/procedure or detecting/determining the first condition, stopping/suspending utilizing the set of resources at least for one or more R2D transmissions and/or one or more D2R transmissions, in accordance with embodiments of the present invention.

FIG. 15 is a flow diagram of a method of a UE in a wireless communication system comprising receiving one or more DL signalings, from a network node, for allocating/scheduling/providing a set of resources, triggering/requesting to perform a second operation/procedure or detecting/determining a second condition in a second timing, which is overlapped with the set of resources in time domain, and keeping utilizing the set of resources at least for the one or more R2D transmissions and/or the one or more D2R transmissions, in accordance with embodiments of the present invention.

FIG. 16 is a flow diagram of a method of a UE in a wireless communication system comprising receiving one or more DL signalings, from a network node, deriving/determining a set of resources based on resource allocation/assignment/configuration in the one or more DL signalings and one or more time occasions of one or more types of transmissions, and utilizing the set of resources at least for one or more R2D transmissions and/or one or more D2R transmissions, in accordance with embodiments of the present invention.

FIG. 17 is a flow diagram of a method of a UE in a wireless communication system comprising receiving one or more DL signalings, from a network node, for allocating/scheduling/providing a set of resources, deriving/determining one or more candidate resources among/from the set of resources, and in response to a trigger/request to transmit a specific message/signaling, performing a specific UL transmission for transmitting/indicating the specific message/signaling in one candidate resource of the one or more candidate resources, in accordance with embodiments of the present invention.

FIG. 18 is a flow diagram of a method of a UE in a wireless communication system comprising receiving, from a network node, a resource allocation, assignment, or configuration for an A-IoT operation or procedure, deriving or determining available resources based on the resource allocation, assignment, or configuration and one or more specific time occasions, and utilizing the available resources at least for performing the A-IoT operation or procedure, in accordance with embodiments of the present invention.

FIG. 19 is a flow diagram of a method of a UE in a wireless communication system comprising receiving, from a network node, a resource allocation, assignment, or configuration for an A-IoT operation or procedure, deriving or determining a set of resources based on the resource allocation, assignment, or configuration, determining an R2D transmission and/or scheduling of a D2R transmission within the set of resources, wherein the determined R2D transmission and/or the scheduled D2R transmission shall avoid overlapping (in time domain) with one or more specific time occasions, and performing the R2D transmission and/or reception of the D2R transmission, in accordance with embodiments of the present invention.

FIG. 20 is a flow diagram of a method of a UE in a wireless communication system comprising receiving, from a network node, a resource allocation, assignment, or configuration for an A-IoT operation or procedure, deriving or determining a set of resources based on the resource allocation, assignment, or configuration, utilizing the set of resources at least for performing the A-IoT operation or procedure, and transmitting or indicating, to the network node, a specific message or signaling associated with utilization of the set of resources or associated with the A-IoT operation or procedure, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-243326, “Solutions for Ambient IoT (Internet of Things) in NR.”; [2]3GPP TR 38.848 V18.0.0 (2023-09) 3GPP; TSG RAN; Study on Ambient IoT (Internet of Things) in RAN (Release 18); [3]3GPP TR 38.769 V2.0.0 (2024-12) 3GPP; TSG RAN; Study on solutions for Ambient IoT (Internet of Things) (Release 19); [4]3GPP TS 38.211 V18.4.0 (2024-09) 3GPP; TSG RAN; NR; Physical channels and modulation (Release 18); and [5]3GPP TS 38.321 V18.4.0 (2024-12) 3GPP; TSG RAN; NR; MAC protocol specification (Release 18). The standards and documents listed above are hereby expressly and fully incorporated herein by reference in their entirety.

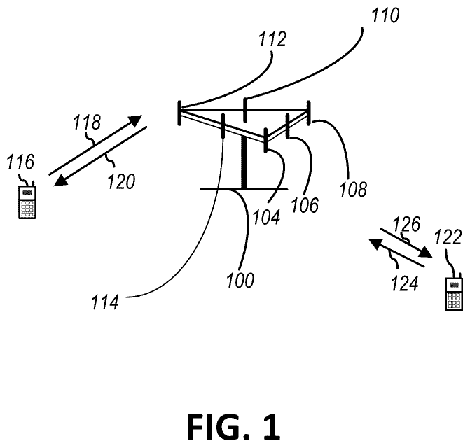

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

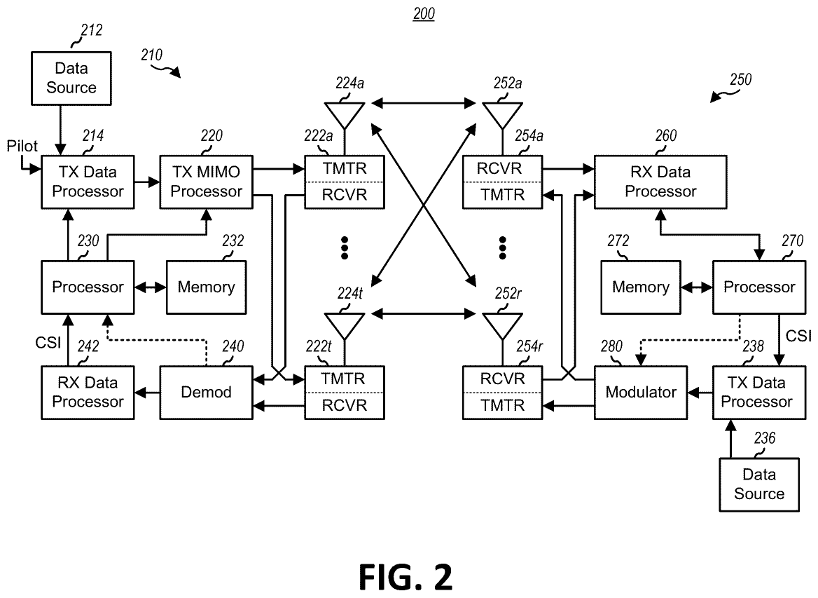

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

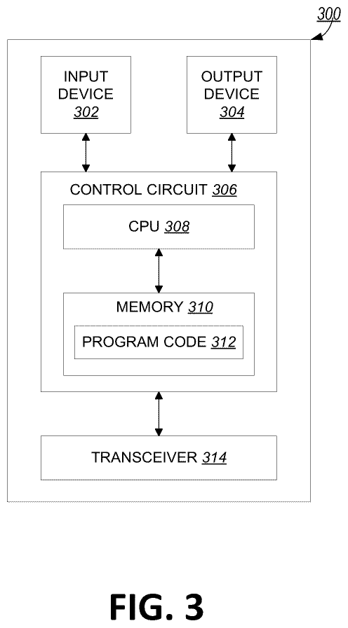

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

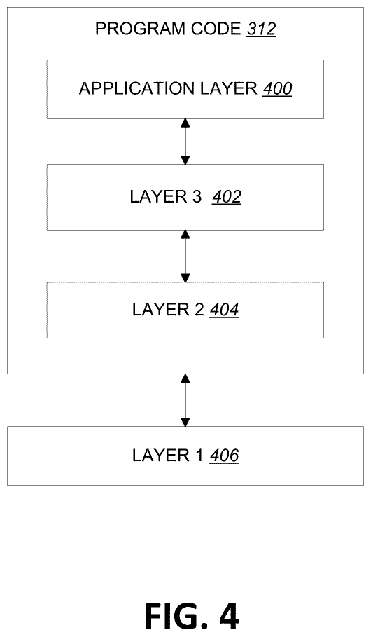

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The work item of ambient Internet of Things (IoT) is specified in [1] RP-243326, as below:

### **************************************Quotation Start [1]**********************************

### 4.1 Objective of SI or Core Part WI or Testing Part WI

. . .

The definitions provided in TR 38.848, TR 38.769, and decisions, etc. made during the Rel-19 SI in RAN WGs are taken into this WI, and the following is the exclusive general scope:
A. The overall objective shall be to standardize the following Ambient IoT device:
   Device 1: ˜1 μW peak power consumption, has energy storage, RF envelope detector receiver, initial sampling frequency offset (SFO) up to 10^{X} ppm, neither R2D nor D2R amplification in the device. The device's D2R transmission is backscattered on a carrier wave provided externally.
B. Deployment scenario 1 with Topology 1, according to D1T1-B.
C. FR1 licensed spectrum in FDD, with R2D in DL spectrum and D2R and CW in UL spectrum.
. . .

WGs begin their discussions from the decisions already made in TR 38.769, with the following refinements for the scope:

The following objectives are set, within the General Scope:
RAN1 scope:
   PRDCH and PDRCH, which are the only physical channels in R2D and D2R, respectively.
   R2D and D2R signal(s)
   Multiplexing/multiple access in R2D is by only TDMA, and in D2R is by only TDMA and FDMA.
   . . .
RAN2 scope:
   Specify the necessary functions and procedures for an Ambient IoT compact protocol stack and lightweight signalling procedure to enable DO-DTT and DT data transmission:
      A-IoT Paging, including subsequent paging for the same service. Support the options that a paging message contains one identifier, and that a paging message contains no identifier. Temporary identifier is not supported, unless required by SA WGs.
      Note: RAN2 aims to design a paging message format such that multiple identifiers can be contained in one paging message, for forward compatibility purposes.
      A-IoT Random access, including re-access for failure handling. Contention-based and contention-free cases are supported. For the contention-based random access, only Solution 1 (3-step only) is included (unless RAN2 decides to use Solution 3 (unified solution) by RAN2 #129).
      A-IoT data transmission, including data (re-)transmission for failure handling. Segmentation is supported at least in D2R.
      Only MAC layer is included

### **************************************Quotation End**************************************

The description for Ambient IoT could be found in TR 38.848 ([2]3GPP TR 38.848 V18.0.0 (2023-09)) and TR 38.769 ([3]3GPP TR 38.769 V2.0.0 (2024-12)), as below:

### **************************************Quotation Start [2]**************************************

### 4.2.1.2 Topology 2: BS↔Intermediate Node↔Ambient IoT Device

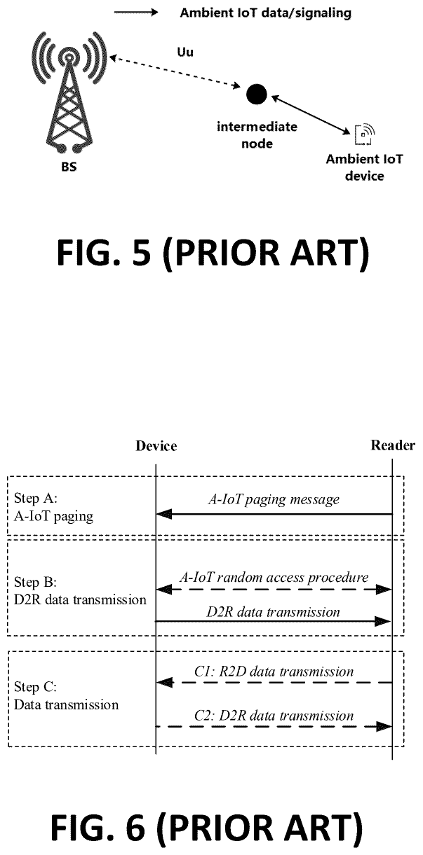

FIG. 5 is a Reproduction of FIG. 4.2.1.2-1: Topology 2, from 3GPP TR 38.848 V18.0.0 (2023-09).

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### **************************************Quotation End**************************************

### **************************************Quotation Start [3]**************************************

### 1 Scope

. . .

Referring to the definitions in [TR 38.848], this is done in the context of:
Deployment scenario 1 (indoor-to-indoor) with Topology 1, and indoor microcell basestation.
Deployment scenario 2 (indoor-to-outdoor) with Topology 2 and indoor UE as intermediate node under network control, and outdoor macrocell basestation.
   . . .

### 3.1 Terms

. . .
Device 1: ˜1 μW peak power consumption, has energy storage, initial sampling frequency offset (SFO) up to 10^{X} ppm, neither R2D nor D2R amplification in the device. The device's D2R transmission is backscattered on a carrier wave provided externally.
Device 2a: ≤a few hundred μW peak power consumption, has energy storage, initial sampling frequency offset (SFO) up to 10^{X} ppm, both R2D and/or D2R amplification in the device. The device's D2R transmission is backscattered on a carrier wave provided externally.
Device 2b: ≤a few hundred μW peak power consumption, has energy storage, initial sampling frequency offset (SFO) up to 10^{X} ppm, both R2D and/or D2R amplification in the device. The device's D2R transmission is generated internally by the device.
D1T1: Deployment scenario 1 with connectivity topology 1, according to TR 38.848.
D2T2: Deployment scenario 2 with connectivity topology 2, according to TR 38.848.
Inventory: The service provided by the network to discover and acquire the identifier of A-IoT device(s).
Command: The service provided by the network to send the operation instruction to the A-IoT device (e.g. read, write, etc.).

### *************************************Next Quotation*************************************

### 6.1 Physical Layer

### 6.1.1 R2D

### 6.1.1.4 R2D Bandwidths

The study defines the following bandwidths for R2D:
Transmission bandwidth, B_{tx,R2D} from a reader perspective: The frequency resources used for transmitting R2D . . . .
Occupied bandwidth, B_{occ,R2D} from a reader perspective: The frequency resources used for transmitting R2D, and potential guard band.
B_{occ,R2D}≥B_{tx,R2D}.
   . . .

### 6.1.1.5 PRDCH

For R2D, the only physical channel is PRDCH, which carries any higher-layer payload (including system information, if defined), and L1 R2D control information, if defined. The following design options have been studied for PRDCH:

. . .

### 6.1.1.9 Scheduling of R2D

For R2D reception, the following information potentially can be explicitly/implicitly indicated to the device via the corresponding PRDCH:
ID associated with device(s) intended for the reception of R2D, potentially including all devices (if supported)

For each information, it is for further study whether higher-layer signalling and/or L1 R2D control signalling is used—see Clause 6.1.1.10.

### 6.1.1.10 R2D Control Information

For transmission of R2D control information for R2D reception and D2R scheduling, following two options are studied and captured in the TR 38.769:
Option 1: L1-control signaling
Option 2: Higher-layer signaling

### *************************************Next Quotation*************************************

### 6.1.2 D2R

### 6.1.2.4 D2R Bandwidths

The following bandwidths for D2R are defined for the purpose of the study:
Transmission bandwidth, B_{tx,D2R}: The frequency resources scheduled by a reader for a D2R transmission from one device.
Occupied bandwidth, B_{occ,D2R}: The transmission bandwidth plus the potential associated intra A-IoT guard-bands totalling B_{guard,D2R}. Note: this guard band is not for coexistence with NR/LTE.
B_{occ,D2R}≥B_{tx,D2R}.
. . .

### 6.1.2.5 PDRCH

For D2R, a physical channel PDRCH carries any higher-layer payload, the response transmitted from device to reader during the contention-based access procedure, and L1 D2R control information, if defined. Scheduling information of PDRCH transmission is provided by a corresponding PRDCH . . .

### 6.1.2.8 Scheduling of D2R

For D2R scheduling, the following information potentially can be explicitly/implicitly indicated to the device via the corresponding PRDCH:
Time domain resources
Frequency domain resources
MCS-like information
Chip duration
ID associated with device(s)
Repetitions
Midamble (if supported) related information

For each information, it is for further study whether higher-layer signalling and/or L1 R2D control signalling is used—see Clause 6.1.1.10.

. . .

### 6.1.4 Random Access

From the perspective of the physical layer, at least when a response is expected from multiple devices that are intended to be identified, an A-IoT contention-based access procedure initiated by the reader is used, for which at least slotted-ALOHA based access and FDMA, are studied. The study of FDMA includes how the frequency domain resources for Msg1 are allocated, and how a device determines that frequency-domain resource allocation.

The response transmitted from the device to the reader during this procedure is transmitted on PDRCH.

A R2D transmission triggering random access determines X time domain resource(s) for D2R transmission(s) for Msg1, where each D2R transmission for Msg1 occurs in one time domain resource of the X time domain resource(s).

### *************************************Next Quotation*************************************

### 6.3 Protocol Stack and Signalling Procedures

### 6.3.1 General Aspects and Overall Procedure

The study aims that the design on the A-IoT radio interface between reader and A-IoT device is common for Topology 1 and Topology 2. The difference of topologies is transparent to the A-IoT devices and has no impact on A-IoT devices. Unless explicitly stated, the descriptions in clause 6.3 apply to all A-IoT device types and both Topology 1 and Topology 2.

FIG. 6 is a Reproduction of FIG. 6.3.1-1 Overall AS Procedures Between A-IoT Device and Reader, from 3GPP TR 38.769 V2.0.0 (2024-12).

The overall AS procedures can be formulated as:
Step A: A-IoT paging. Based on the service request, the reader sends the A-IoT paging message indicating device(s) that need to respond. See clause 6.3.3.
Step B: D2R data (device ID) transmission. Triggered A-IoT device(s) perform the device ID transmission via the A-IoT random access procedure or without using the A-IoT random access procedure. See clause 6.3.4 (and 6.3.5).
Step C1: Possible R2D data transmission (e.g., for sending the command). See clause 6.3.5.
Step C2: Possible D2R data transmission (e.g., the corresponding response to command). See clause 6.3.5.
. . .

### 6.3.2 Protocol Stack and Functionality Aspects

For A-IoT, it is assumed the commands (e.g., read/write/disable) and/or inventory information are carried over A-IoT radio interface as the upper layer data.

. . .

As to the A-IoT required functionalities, the following functionalities are supported:
A-IoT paging (see clause 6.3.3)
A-IoT random access procedure (see clause 6.3.4)
A-IoT data transmission (see clause 6.3.5)
   . . .

### 6.3.4 A-IoT Random Access Procedure

A-IoT random access procedure is used for the Ambient IoT device(s) to access the network for data transmission.

The A-IoT random access procedure is triggered by the reader, including triggering the access for a single A-IoT device, group of A-IoT devices, or all A-IoT devices under the coverage of the reader.

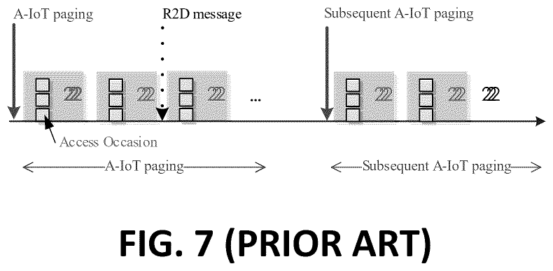

. . .
FIG. 7 is a Reproduction of FIG. 6.3.4-1 General Framework of Slotted-ALOHA for A-IoT Random access procedure, from 3GPP TR 38.769 V2.0.0 (2024-12).

Access occasion: An opportunity of time-frequency resource for A-IoT device(s) to perform access (e.g., transmitting the A-IoT Msg1 by the device). A set of access occasion(s) for different A-IoT device(s) is scheduled via the R2D message (referring to the “R2D transmission triggering random access” in clause 6.1.4) by the reader.

When the A-IoT device is selected to respond in accordance to the clause 6.3.3, the A-IoT device performs the following procedure:
Step 1: Random access type (i.e., contention-free or contention-based) and access occasion/resource determination:
   The A-IoT device determines the random access type from the A-IoT paging message, in accordance to clause 6.3.3. The reader can configure either contention-free access or contention-based random access (and the corresponding configurations). It needs to be further discussed on whether it is explicitly or implicitly.
   If the random access is contention-free access:
      Selects the indicated D2R occasion/resource;
      Skips the contention resolution in Step 2 and performs the data transmission in accordance to clause 6.3.5.
   If the random access is contention-based random access:
      Performs access occasion/resource selection: as the baseline for CBRA, at least for TDMA case, the device can randomly select one access occasion for A-IoT Msg1 within the access occasions provided/assigned by the reader. It needs to be further discussed if this is applicable to FDMA case. Further enhancement option(s) can be also considered after more physical layer detailed design on TDMA and FDMA;
   Performs the Step 2 for contention resolution.
Step 2: Contention resolution of contention-based random access:
   . . .
      A-IoT Msg1: When the A-IoT device identifies the start of its own access occasion, it sends one 16-bit random ID generated by the A-IoT device to the reader.
      A-IoT Msg2: The reader responds with the successfully received random ID.
      If the A-IoT device receives the A-IoT Msg2 including a random ID, which is the same as the previously transmitted one in A-IoT Msg1, it considers the contention resolution as successful.
   . . .
NOTE 1: The random ID is randomly generated by the A-IoT device.
NOTE 2: The A-IoT Msg2 is used for contention resolution, since it is assumed that the size of random ID in A-IoT Msg1 should be sufficient for contention resolution purpose. It is assumed that, with the sufficient range for random ID, the probability of multiple A-IoT devices selecting the same access occasion and the same random ID for A-IoT Msg1 transmission will be sufficiently low.
   . . .

After the A-IoT device considers the contention resolution as successful if the contention-based random access is used, or if the contention-free access is used, it may perform the upper layer data transmission with the reader, which can be the device ID and/or any other upper layer data, if any, in accordance to clause 6.3.5.
. . .

### 6.3.5 A-IoT Data Transmission

. . .

The handling of data transmission failure has been studied. It is understood that the subsequent R2D data transmission after the D2R data transmission does not need to be always sent. In case of D2R data transmission failure, the A-IoT device follows the reader subsequent R2D instruction, if any.
For instance, the reader can repeat the R2D upper layer “command” to trigger the A-IoT device to re-send the same D2R upper layer “response” (i.e., the A-IoT device just follows the received R2D to transmit following D2R).
For instance, the reader can re-send A-IoT Msg2 to specific device(s) to echo the random ID(s), in case of failure reception of corresponding D2R data transmission (i.e. “Msg3”) after the initial A-IoT Msg2, together with the corresponding D2R resource scheduling. This can trigger the A-IoT device to re-send the same D2R data transmision (i.e. “Msg3”). If it is supported to include the echoed random IDs for multiple devices, the re-sent A-IoT Msg2 only includes the random IDs of the devices, whose “Msg3” is not successfully received.
. . .

### 6.3.6 Topology 2 Aspects on the Interface Between UE Reader and RAN

For Topology 2, the architecture/protocol stack options in [TR 23.700-13] are studied (also corresponding to the studies in clause 6.4.2.1), while no new AS layer architecture/protocol stack options will be studied:
RRC based solution: A-IoT upper layer information is explicitly forwarded via UE reader's NR Uu RRC message.
. . .

It is assumed that the intermediate UE authorization is performed by upper layers. It is not studied, from RAN2 signalling perspective, the scenario to support bistatic mode of operation (e.g., D2T2-A1).

The radio resources used by A-IoT radio interface between the A-IoT device(s) and UE reader are controlled by the network. The radio resources, which are dedicated for a UE reader, are only configured to the UE reader via dedicated signalling. The mechanisms for shared resource pool amongst UE readers are not considered in this release. The UE reader in coverage of BS scenario is supported. The UE reader may perform the A-IoT procedure on A-IoT radio interface between the reader and the device(s), only if the radio resource configuration is valid in the cell, which is under network control. The radio resource validity across multiple cells is not supported in this release. Hence, for all options below, the resources remain valid only in the same cell in which the resources were configured.

For the case when the radio resources are allocated semi-statically by the network, the radio resource validities are studied in the following scenarios with candidate options (down-selection can be decided in the WI phase):
Scenario 1: In RRC_CONNECTED, the UE reader can perform A-IoT operations using the allocated A-IoT radio resource for A-IoT radio interface:
   Option 1: UE reader receives the resources configuration in NR Uu dedicated RRC signalling. The radio resources remain valid until the network releases them explicitly. This would be supported by the NR Uu RRC reconfiguration; and/or
   Option 2: UE reader receives the resources configuration in NR Uu dedicated RRC signalling, which configures a time period in which the corresponding resource can be used. The UE reader considers that the resources remain valid for that time period, unless the resource configuration is explicitly released by the network by the NR Uu RRC reconfiguration.
Scenario 2: In RRC_CONNECTED, the UE reader can perform A-IoT operations using the allocated A-IoT radio resource for A-IoT radio interface, upon its temporary out of connection scenarios (e.g., RLF and handover cases):
   Option 1: The UE reader considers the resources as temporarily invalid during the temporary out of connection condition. The resource may become valid again after the UE recovers from the condition.
   Option 2: The UE reader considers that the resources remain valid for a time period. It needs to be further discussed on whether this time period belongs to the one in Option 2 for Scenario 1 or is a different time period. It needs to be further discussed on whether the duration of this time period is related to the ongoing A-IoT operations.

NOTE 1: The A-IoT radio resource can be (re)configured by UE reader's RRC reconfiguration (including during handover procedure, after re-establishment of the UE reader, etc.)
. . .

For the radio resources allocation request, following alternatives are studied:
Alternative 1: BS configures/allocates a set A-IoT radio resource to the UE reader, in response to a request from the UE reader; and/or
Alternative 2: BS configures/allocates a set A-IoT radio resource to the UE reader, based on the service request from CN.
NOTE 2: The above two alternatives can co-exist. The configuration for radio resource allocation may also include the validity criteria (if applicable, see the time period in previous option 2 of those scenarios)

### *************************************Next Quotation*************************************

### 6.4 RAN Architecture Aspects

The logical system architecture for A-IoT consists of the following architectural elements:
A-IoT device: Equipment with characteristics outlined e.g., in TS 22.369 and TR 38.848.
A-IoT RAN: Hosts certain functions for A-IoT as part of the functional in RAN.
A-IoT radio: Radio interface between A-IoT device and A-IoT RAN node in topology 1 and between A-IoT device and A-IoT-enabled UE in topology 2.
A-IoT CN: Hosts certain functions for A-IoT as of the functional in CN.
. . .
XX interface: Interface between the A-IoT RAN/A-IoT-enabled gNB and the A-IoT CN on which certain A-IoT specific functions are performed.

XX interface is NG interface, NGAP is used between A-IoT RAN and AIoT CN.
NOTE 3: How the functions represented by the XX interfaces are defined in various solutions and A-IoT CN topologies (direct/indirect connection between AIoT RAN and AIOTF).
Common reader function: A function that communicates with the A-IoT device by means of A-IoT radio.
A-IoT RAN node function: A function that contains e.g., the control of the A-IoT radio resources used towards the A-IoT device.
   . . .

### 6.4.2 Support of Topology 2

FIG. 6.4.2-1 depicts a logical system architecture for topology 2, where the Common reader function is located at an A-IoT-enabled UE, and the A-IoT RAN node function is located at an A-IoT-enabled gNB.

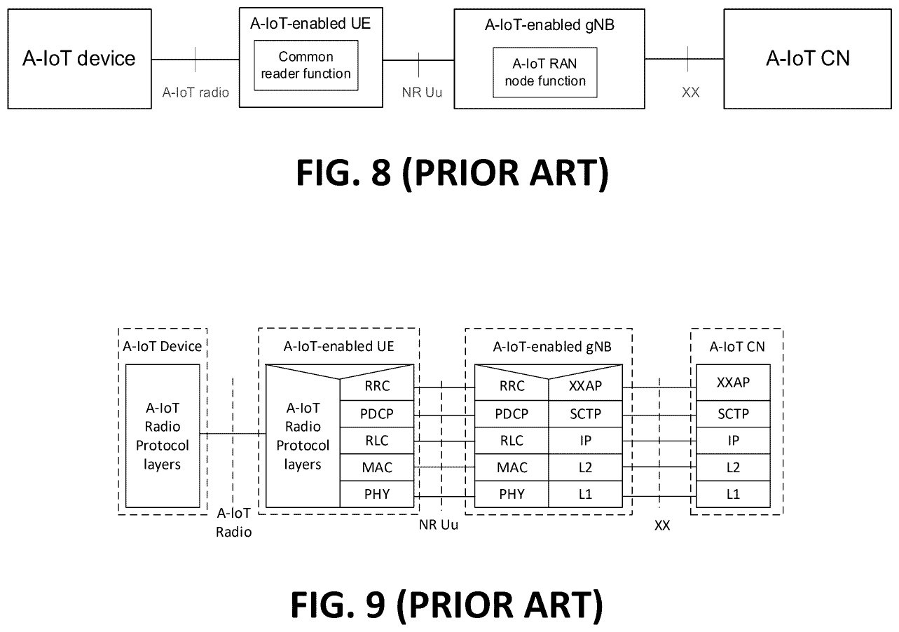

The following definitions apply:
A-IoT-enabled gNB: A gNB supporting A-IoT RAN node function in topology 2, which is able to communicate with the A-IoT-enabled UE via NR Uu interface.
A-IoT-enabled UE: A UE supporting Common reader function, which is able to communicate with the A-IoT device via the A-IoT radio interface.
   FIG. 8 is a Reproduction of FIG. 6.4.2-1 Logical System Architecture for Topology 2, from 3GPP TR 38.769 V2.0.0 (2024-12).
NOTE 1: FIG. 6.4.2-1 doesn't illustrate the protocol between A-IoT enabled UE and A-IoT CN, if needed.
NOTE 2: The A-IoT CN could include AMF, UPF and A-IoTF, which is up to SA2 decision.
NOTE 3: Details of the radio resource management performed by the A-IoT enabled gNB are subject to RAN1 and RAN2 mechanisms.

For Topology 2, architecture and protocol aspects of split RAN architecture are not studied.

In Topology 2, XX interface is NG interface.

In Topology 2, the RAN architecture should enable the coordination of the usage of the A-IoT radio resources among readers.
NOTE 4: How to perform coordination of the usage of the A-IoT radio resources among readers needs further discussion.

An A-IoT-enabled gNB could support both topology 1 and topology 2, this is an implementation matter.

### 6.4.2.1 Solutions for Topology 2

### 6.4.2.1.0 General

To support Topology 2, the following solutions are to be studied for conveying A-IoT upper layer information:
RRC based solution. With this solution, A-IoT CN applies A-IoT upper layer information explicitly over XXAP signaling. A-IoT upper layer information is then relayed explicitly to/from the A-IoT-enabled UE via NR Uu RRC.
   . . .

Only if the UE is authorized to perform the A-IoT service, the UE can communicate with the A-IoT device and be configured with AIoT radio resources controlled by the A-IoT enabled gNB.

FIG. 9 is a Reproduction of FIG. 6.4.2.1.1-1: RRC Based Solution of Topology 2, from 3GPP TR 38.769 V2.0.0 (2024-12).
. . .

### 6.5.3 Signaling and Procedures for Topology 2

6.5.3.1 Candidate procedures for A-IoT Inventory for Topology 2

### 6.5.3.1.1 RRC Based Solution

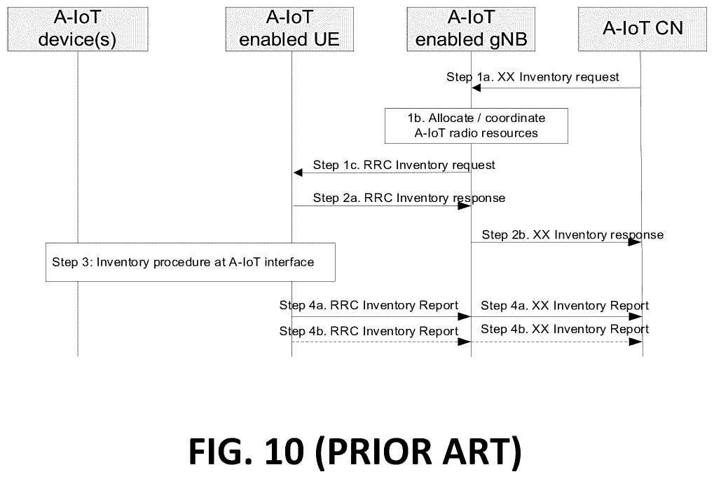

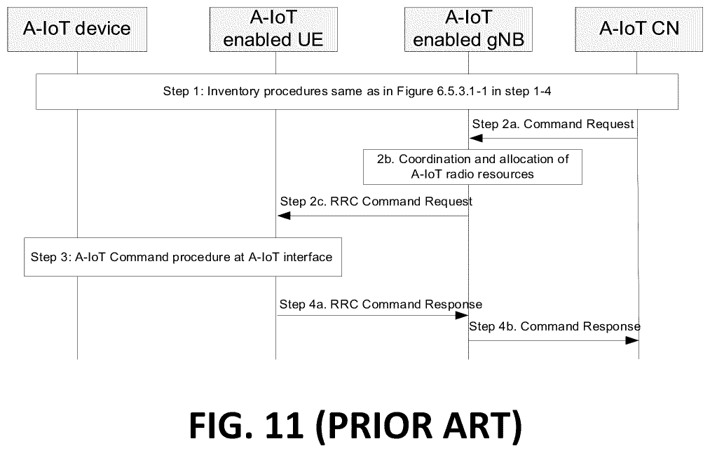

FIG. 10 is a Reproduction of FIG. 6.5.3.1.1-1: Message Flow for A-IoT Inventory in Topology 2—RRC-Based Solution, from 3GPP TR 38.769 V2.0.0 (2024-12).
1a. The A-IoT CN sends an Inventory request message to the A-IoT enabled gNB
1b. The A-IoT enabled gNB allocates and coordinates usage of A-IoT radio resources.
1c/2a RRC communication with the A-IoT enabled UE takes place.
NOTE 1: RRC based communication is only depicted schematically, details subject to RAN2.
2. The A-IoT-enabled gNB sends an Inventory response message to the A-IoT CN.
NOTE 2: In step 2, the A-IoT-enabled gNB may instead send an Inventory failure message to the A-IoT CN indicating that the inventory procedure could not be initiated towards the A-IoT device(s).
3. The A-IoT-enabled gNB requests the A-IoT-enabled UE(s) to trigger inventory procedure towards the A-IoT device(s).
4a/4b. After receiving inventory result reported from the A-IoT enabled UEs, the A-IoT-enabled gNB may send one or multiple Inventory reports towards the A-IoT CN including the received inventory result.
NOTE 3: Steps 4a/4b may happen in parallel with Step 3 for different A-IoT devices.
NOTE 4: Step 4a/4b between A-IoT-enable UE and A-IoT-enabled gNB subject to RAN2.
   . . .

### 6.5.3.2 Candidate Procedures for A-IoT Command for Topology 2

### 6.5.3.2.1 RRC Based Solution

FIG. 11 is a Reproduction of FIG. 6.5.3.2-1: Message Flow for A-IoT Command in Topology 2 (RRC-Based Solution), from 3GPP TR 38.769 V2.0.0 (2024-12).
1. The Inventory procedures are performed in step 1, which are the same as in FIG. 6.5.3.1.1-1 in step 1-4.
NOTE 1: Step 1 ais performed for the “A-IoT Inventory and Command” case, Whether and under which conditions step 1 may be skipped in case of “Command-only” and which consequences this would have for the overall message flow depends on discussions led by SA2, SA3 and RAN2.
NOTE 2: Whether and which way steps 2a, 2b and 2c may be part of step 1 is dependent on discussions led by SA2, SA3 and RAN2.
2a. The A-IoT CN sends a Command Request message to the A-IoT enabled gNB.
2b. The A-IoT enabled gNB coordinates A-IoT radio resources and allocates A-IoT radio resources to the A-IoT enabled UE accordingly.
2c. The A-IoT enabled gNB sends a RRC Command Request message to the A-IoT enabled UE.

NOTE 3: RRC based communication, i.e., performing the A-IoT Command procedure and allocation of A-IoT radio resources, is only depicted schematically, details subject to RAN2.
3. The A-IoT-enabled UE performs A-IoT command procedures at A-IoT interface towards the A-IoT device over the A-IoT radio interface.
4a. A-IoT enabled UE sends a Command Response message to A-IoT enabled gNB, if the command result is received from A-IoT device, the A-IoT enabled UE may include the command result in the Command Response message.
4b. The A-IoT enabled gNB sends a Command Response message to the A-IoT CN, it may include the command result in the Command Response message, if any.
NOTE 4: In step 4b, the A-IoT enabled gNB may instead send a Command Failure message to the A-IoT CN indicating that the command procedure is failed towards the A-IoT device.

### *************************************Next Quotation*************************************

### 6.7.3 Intermediate Node (UE)

### 6.7.3.1 General

The intermediate UE, under NW control, can send Ambient IoT data and/or signalling to the device, and receive the backscatter signal from the device. The intermediate UE can also operate as a legacy NR UE. For simplicity, non-concurrent operation of Ambient IoT and NR for intermediate UE is assumed, and focus on the case where the intermediate UE acts as an A-IoT Reader.

Considering the intermediate UE need to support both A-IoT and NR operation and if the requirements in NR and A-IoT is the same, it is possible to verify only on the NR side.

### **************************************Quotation End**************************************

The description related to physical resource in Uu interface in current standard is specified in TS 38.211 ([4]3GPP TS 38.211 V18.4.0 (2024-09)) and TS 38.321 ([5]3GPP TS 38.321 V18.4.0 (2024-12)):

### **************************************Quotation Start [4]**************************************

### 4.2 Numerologies

Multiple OFDM numerologies are supported as given by Table 4.2-1 where y and the cyclic prefix for a downlink or uplink bandwidth part are obtained from the higher-layer parameters subcarrierSpacing and cyclicPrefix, respectively.

TABLE 4.2-1
Supported transmission numerologies.

| μ | Δf = 2^{μ} · 15[kHz] | Cyclic prefix |
|---|---|---|
| 0 | 15 | Normal |
| 1 | 30 | Normal |
| 2 | 60 | Normal, Extended |

. . .

### 4.4 Physical Resources

### 4.4.2 Resource Grid

For each numerology and carrier, a resource grid of

$${N}_{grid , x}^{size , μ} {N}_{sc}^{RB}$$

subcarriers and

$${N}_{symb}^{s u b f r a m e , μ}$$

OFDM symbols is defined, starting at common resource block

$${N}_{g r i d}^{start , μ}$$

indicated by higher-layer signalling. There is one set of resource grids per transmission direction (uplink, downlink, or sidelink) with the subscript x set to DL, UL, and SL for downlink, uplink, and sidelink, respectively. When there is no risk for confusion, the subscript x may be dropped. There is one resource grid for a given antenna port p, subcarrier spacing configuration p, and transmission direction (downlink, uplink, or sidelink).
. . .

### 4.4.3 Resource Elements

Each element in the resource grid for antenna port p and subcarrier spacing configuration μ is called a resource element and is uniquely identified by (k,l)_{p,μ} where k is the index in the frequency domain and l refers to the symbol position in the time domain relative to some reference point. Resource element (k,l)_{p,μ} corresponds to a physical resource and the complex value

$${a}_{k , l}^{( p , μ )} .$$

### 4.4.4 Resource Blocks

### 4.4.4.1 General

A resource block is defined as

$${N}_{s c}^{R B} = 12$$

consecutive subcarriers in the frequency domain.
. . .

### 4.4.4.4 Physical Resource Blocks

Physical resource blocks for subcarrier spacing configuration y are defined within a bandwidth part and numbered from 0 to

$${N}_{BWP , i}^{s ize , μ} - 1$$

where i is the number of the bandwidth part. The relation between the physical resource block

$${n}_{P R B}^{μ}$$

in bandwidth part i and the common resource block

$${n}_{CRB}^{μ}$$

is given by

$${n}_{CRB}^{μ} = {n}_{P R B}^{μ} + {N}_{B WP , i}^{s t art , μ}$$

where

$${N}_{B WP , i}^{s t art , μ}$$

is the common resource block where bandwidth part i starts relative to common resource block 0. When there is no risk for confusion the index μ may be dropped.

### **************************************Quotation End**************************************

### **************************************Quotation Start [5]**********************************

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300. There is only one Random Access procedure ongoing at any point in time in a MAC entity. The Random Access procedure on an SCell or an LTM candidate cell shall only be initiated by a PDCCH order with ra-PreambleIndex different from 0b000000.

. . .

### 5.2 Maintenance of Uplink Time Alignment

RRC configures the following parameters for the maintenance of UL time alignment:
timeAlignmentTimer (per TAG) which controls how long the MAC entity considers the Serving Cells to the associated TAG to be uplink time aligned for the TAG;
. . .

The MAC entity shall:
1>when a Timing Advance Command MAC CE is received, and if an NTA (as defined in TS 38.211) has been maintained with the indicated TAG:
   2>apply the Timing Advance Command for the indicated TAG;
   . . .
1>when a Timing Advance Command is received in a Random Access Response message for a Serving Cell not configured with two TAGs or in a MSGB for an SpCell not configured with two TAGs:
   2>if the Random Access Preamble was not selected by the MAC entity among the contention-based Random Access Preamble:
      3>apply the Timing Advance Command for this TAG;
      3>start or restart the timeAlignmentTimer associated with this TAG.
   2>else if the timeAlignmentTimer associated with this TAG is not running:
      3>apply the Timing Advance Command for this TAG;
      3>start the timeAlignmentTimer associated with this TAG;
      3>when the Contention Resolution is considered not successful as described in clause 5.1.5; or
      3>when the Contention Resolution is considered successful for SI request as described in clause 5.1.5, after transmitting HARQ feedback for MAC PDU including UE Contention Resolution Identity MAC CE:
         4>stop timeAlignmentTimer associated with this TAG.
      . . .
   2>else:
      3>ignore the received Timing Advance Command.
      . . .
1>when an LTM Cell Switch Command MAC CE is received and the Timing Advance Command is not set as FFF:
   2>apply the Timing Advance Command for the PTAG as specified in clause 6.1.3.75;
   2>start or restart the timeAlignmentTimer associated with the PTAG as specified in clause 6.1.3.75.
1>when an LTM Cell Switch Command MAC CE is received, and the Timing Advance Command is set as FFF, and the UE has successfully measured the Timing Advance as in clause 5.18.35:
   2>apply the measured Timing Advance for the PTAG;
   2>start or restart the timeAlignmentTimer associated with the PTAG.
1>when a timeAlignmentTimer expires:
   2>if the timeAlignmentTimer is associated with a PTAG and the SpCell is not configured with two PTAGs; or
   2>if the timeAlignmentTimer is associated with a PTAG, the SpCell is configured with two PTAGs, and the timeAlignmentTimer associated with the other PTAG is not running:
      3>flush all HARQ buffers for all Serving Cells;
      3>notify RRC to release PUCCH for all Serving Cells, if configured;
      3>notify RRC to release SRS for all Serving Cells, if configured;
      3>clear any configured downlink assignments and configured uplink grants;
      3>clear any PUSCH resource for semi-persistent CSI reporting;
      3>consider all running timeAlignmentTimers as expired;
      3>maintain NTA (defined in TS 38.211) of all TAGs.
   2>else:
      3>if the timeAlignmentTimer is associated with a TAG for an SCell configured with only this TAG; or
      3>if the timeAlignmentTimer is associated with a TAG for an SCell, and if the SCell is configured with two TAGs and the timeAlignmentTimer associated with the other TAG is not running:
         4>flush all HARQ buffers for all such SCells;
         4>notify RRC to release PUCCH, if configured for all such SCells;
         4>notify RRC to release SRS, if configured for all such SCells;
         4>clear any configured downlink assignments and configured uplink grants for all such SCells;
         4>clear any PUSCH resource for semi-persistent CSI reporting for all such SCells;
         4>maintain NTA (defined in TS 38.211) of this TAG.

### **************************************Quotation End**************************************

An Ambient Internet of Things (or A-IoT) device would have ultra-low complexity, very small device size, and long life cycle. The Ambient IoT device would have complexity and power consumption orders of magnitude lower than the existing 3GPP Low-Power Wide-Area (LPWA) technologies (e.g., Narrowband (NB)-IoT, enhanced Machine-Type Communication (eMTC)). The energy of the Ambient IoT device may be provided through the harvesting of carrier waves, radio waves, light, motion, heat, or any other power source that could be suitable. In one embodiment, the power/energy of Ambient IoT device may be provided from a carrier wave from the network and/or an intermediate node. In Topology 1, the Ambient IoT device would directly and bidirectionally communicate with a base station. In Topology 2, the Ambient IoT device would communicate bidirectionally with an intermediate node (e.g., a User Equipment (UE)) between the Ambient IoT device and the base station. The Uplink (UL) transmission of the Ambient IoT device may be generated internally by the device or be backscattered on the carrier wave provided externally.

In New Radio (NR) Uu-interface, network node (e.g., base station, Next Generation Node B (gNB)) may transmit Physical Downlink Control Channel (PDCCH) carrying Downlink Control Information (DCI) to a UE. The downlink control information may schedule/provide Downlink (DL) assignments such that the UE receives a DL transmission (e.g., Physical Downlink Shared Channel (PDSCH)) from the network node or may schedule/provide the UL grant such that the UE performs UL transmission (e.g., Physical Uplink Shared Channel (PUSCH)) to the network node. Physical Resource Block (PRB)-based resource allocation in frequency domain is supported for PDSCH and PUSCH. One PRB comprises multiple Resource Elements (REs), e.g., one PRB consists of 12 REs. Note that the DL and UL are on Uu interface, which means the wireless interface for communication between network node and UE.

For NR sidelink, sidelink slots can be utilized for Physical Sidelink Control Channel (PSCCH)/Physical Sidelink Shared Channel (PSSCH)/Physical Sidelink Feedback Channel (PSFCH) transmission/reception. Moreover, the concept of sidelink resource pool for sidelink communication is utilized for PSCCH/PSSCH and/or PSFCH transmission/reception. A sidelink (communication) resource pool will comprise a set of sidelink slots (except at least slots for Physical Sidelink Broadcast Channel (PSBCH)) and a set of frequency resources. The set of sidelink slots may not be consecutive in time domains. Different sidelink (communication) resource pools may be Time Division Multiplexed (TDMed) and/or Frequency Division Multiplexed (FDMed). One sidelink (communication) resource pool will comprise multiple sub-channels in frequency domain, wherein a sub-channel comprises multiple consecutive PRBs in frequency domain. Configuration of the sidelink resource pool will indicate the number of PRBs of each sub-channel in the corresponding sidelink resource pool. Sub-channel based resource allocation in frequency domain is supported for PSSCH.

In NR sidelink design, there are two sidelink resource allocation modes defined for NR sidelink communication:
Mode 1 is that a base station/network node can schedule sidelink resource(s) to be used by a UE for sidelink transmission(s);
Mode 2 is that a UE determines (i.e., base station/network node does not schedule) sidelink transmission resource(s) within sidelink resources configured by a network node or pre-configured.

Note that the Sidelink (SL) are on PC5 interfaces which means the wireless interface for communication is (directly) between UEs/devices.

For Ambient IoT, it is considered to design a (random) access procedure and command operation. The (random) access procedure for Ambient IoT may be more like inventory operation. The command operation for Ambient IoT may be more like device data communication operation.

In Deployment scenario 2 with Topology 2 (D2T2), an intermediate node may operate as a reader, wherein the intermediate node can be a UE under network control. In other words, resources utilized for Reader-to-Device (R2D) and Device-to-Reader (D2R) between the intermediate node (e.g., UE reader) and Ambient IoT device(s)/UE(s) should be under network control, e.g., scheduled by the network node. If a carrier wave is also inside topology (e.g., transmitted by UE or network node), resources utilized for carrier waves should be under network control as well. According to Table 6.6.1-1 of TR 38.769 ([3]3GPP TR 38.769 V2.0.0 (2024-12)), in D2T2, R2D transmission/reception is performed in the UL spectrum, and D2R transmission/reception is performed in the UL spectrum and optional in the DL spectrum.

Although sidelink operation is designed for communication on PC5 interface between UEs or devices, there are some differences from Ambient IoT D2T2. For instance, the intermediate node can perform R2D transmission such that the start of the R2D transmission aligns with the boundary of an NR Orthogonal Frequency-Division Multiplexing (OFDM) symbol (including the Cyclic Prefix (CP)). Start of NR sidelink transmission from sidelink UE(s) can also align with the boundary of an NR OFDM symbol. However, due to Sampling Frequency Offset (SFO), Ambient IoT device/UE(s) are hard to achieve such alignment. Thus, the intermediate node and even the network cannot fully/accurately control the start of each D2R transmission in time domain. For another instance, the resources amount required for NR sidelink transmissions from a sidelink Transmission (TX) UE can be predictable, since it only needs to consider sidelink data buffer of the sidelink TX UE. The sidelink TX UE only needs to determine its sidelink transmission resource. However, the intermediate node needs to not only determine its R2D transmission resources but also schedule D2R transmission resources. The intermediate node may not even exactly know how many Ambient IoT device(s)/UE(s) will be served or inventoried, especially an inventory procedure or contention-based (random) access procedure will not be counted/considered in the sidelink data buffer of the intermediate node. Thus, the amount of resources required for the intermediate node to perform Ambient IoT transmissions/receptions will be hard to predict fully/accurately, such that the network will be hard to allocate accurate resources to the intermediate node. For another instance, the Ambient IoT operation may require resources in a time period, which may be better to be contiguous. The contiguous time period for Ambient IoT operation can avoid potential interruption of the Ambient IoT operation, e.g., carrier wave transmission, R2D transmission, or D2R transmission, especially considering that the resource of the R2D transmission and/or the D2R transmission can extend only in time domain, not in frequency domain. In comparison, a sidelink resource pool utilized for sidelink operation can use consecutive sidelink slots, wherein the consecutive sidelink slots can be discontinuous in physical time domain.

According to TR 38.769 ([3]3GPP TR 38.769 V2.0.0 (2024-12)), for resource allocation and/or controlling of the intermediate UE (or UE reader) in topology 2 for R2D and D2R transmissions via the Uu interface between the network node and intermediate UE, Option 1: Higher-layer signaling and/or Option 2: physical-layer and higher-layer signaling can be studied.

For the case when resources for the UE reader in topology 2 are allocated semi-statically via higher-layer signaling by the network, the UE reader may receive the resources configuration in NR Uu dedicated Radio Resource Control (RRC) signaling. Preferably in certain embodiments, the resources may remain valid until the network releases them explicitly. Alternatively, the resources may be configured with a time period to be used, and the UE reader considers that the resources remain valid for that time period, unless the resource configuration is explicitly released by the network. Moreover, when the UE reader is temporary out of connection scenarios (e.g., Radio Link Failure (RLF) and handover cases), it needs to be studied whether the UE reader can perform Ambient IoT operations using the allocated resources for A-IoT radio interface, and whether allocated resource may become valid again after the UE reader recovers from the temporary out of connection scenarios.

For the UE reader in topology 2, the UE may not only perform Ambient IoT operations but also DL/UL operation. It is possible that the UE reader may encounter TX/TX collision, e.g., R2D transmission and UL transmission (e.g., in UL spectrum) in the same time. It is also possible that the UE reader may encounter TX/Reception (RX) collision, e.g., D2R reception and UL transmission (e.g., in UL spectrum) at the same time. Moreover, if D2R transmission/reception is performed in DL spectrum, it is also possible that the D2R transmission/reception collides with DL transmission/reception. Accordingly, it may need some handling for dealing with these collision cases. Moreover, after performing Ambient IoT operations, the UE may need to report some related data/information to the network node. How to derive/acquire corresponding resources is also for further study.

To deal with the above issues, some concepts, mechanisms, methods, aspects, and embodiments are provided in the following.

A network node may allocate/schedule/assign/provide/indicate a set of resources for/to a UE (e.g., intermediate UE or UE reader). Preferably in certain embodiments, the network node may transmit one or more DL signalings to allocate/schedule/assign/provide/indicate the set of resources. When the UE receives the one or more DL signalings, the UE may derive/determine the set of resources based on (resource allocation/assignment/configuration in) the one or more DL signalings. Preferably in certain embodiments, the set of resources may be utilized by the UE at least for Ambient IoT-related operations/procedures. Preferably in certain embodiments, the set of resources may be utilized at least for one or more R2D transmissions and/or one or more D2R transmissions and/or carrier wave transmissions. Preferably in certain embodiments, an R2D transmission means a transmission from the UE to (Ambient IoT) device(s). Preferably in certain embodiments, a D2R transmission means a transmission from an (Ambient IoT) device to the UE. Preferably in certain embodiments, the carrier wave transmission may be transmitted from the UE for (Ambient IoT) device(s)'s backscattered D2R transmission.

Preferably in certain embodiments, the set of resources may be one or more resources in time and/or frequency domain. Preferably in certain embodiments, the one or more resources may be located in consecutive/continuous Transmission Time Intervals (TTIs). Preferably in certain embodiments, the one or more resources may be continuous in time domain. Preferably in certain embodiments, the one or more DL signalings may indicate a starting timing and/or a number of (consecutive/continuous) TTIs of/for the one or more resources. Preferably in certain embodiments, the one or more DL signalings may indicate a starting timing and/or a (consecutive/continuous) time duration/period of/for the one or more resources. Preferably in certain embodiments, the one or more DL signalings may indicate a starting timing of/for the one or more resources, and a deactivation/release signaling (from the network node to the UE) may indicate an ending timing of/for the one or more resources. Preferably in certain embodiments, the one or more DL signalings may comprise higher-layer signaling and/or physical-layer signaling. The higher-layer signaling may comprise a (dedicated) RRC signaling/configuration. The physical-layer signaling may comprise downlink control information for activation.

Preferably in certain embodiments, the UE may utilize the set of resources for performing Ambient IoT-related operations/procedures, e.g., Ambient IoT (random) access procedure and/or Ambient IoT command/communication operation.

Preferably in certain embodiments, the UE may perform a first R2D transmission in a first resource among the set of resources. Preferably in certain embodiments, the first resource may be in a UL carrier/cell or UL Bandwidth Part (BWP) or UL spectrum. Preferably in certain embodiments, the set of resources may be in the UL carrier/cell or the UL BWP or the UL spectrum. The first R2D transmission may be an A-IoT paging message. The UE may transmit the first R2D transmission to one or more A-IoT devices. The first R2D transmission may be used to trigger one or more (A-IoT) Random Access (RA) procedures (e.g., from the one or more A-IoT devices). The first R2D transmission may include/schedule/indicate one or more resource(s) of one or more D2R transmissions. The one or more resource(s) of the one or more D2R transmissions may be selected from the set of resources.

Preferably in certain embodiments, the UE may receive a second D2R transmission in a second resource among the set of resources. The second D2R transmission may be Message 1 (Msg1) or Message 3 (Msg3) of an (A-IoT) RA procedure. The second D2R transmission may be a response of the first R2D transmission. The second resource may be scheduled/indicated (or included) in the first R2D transmission. Preferably in certain embodiments, the second resource may be in the UL carrier/cell or the UL BWP or the UL spectrum. It means that the first resource and the second resource are in the same UL carrier/cell/BWP/spectrum. The set of resources may be in the UL carrier/cell/BWP/spectrum. Alternatively and/or preferably in certain embodiments, the second resource may be in a DL carrier/cell or DL BWP or DL spectrum. It means that the set of resources may comprise a first set of resources in the UL carrier/cell/BWP/spectrum and a second set of resources in the DL carrier/cell/BWP/spectrum. The first resource is in the first set of resources, and the second resource is in the second set of resources. Alternatively and/or preferably in certain embodiments, the second resource may be in the same carrier/cell/BWP/spectrum (e.g., unpaired spectrum) as the first resource. It means that the set of resources may comprise a first set of resources in one or more UL symbols in the carrier/cell/BWP/spectrum and a second set of resources in one or more DL symbols in the carrier/cell/BWP/spectrum. The set of resources may also comprise a third set of resources in one or more Flexible/Gap symbols in the carrier/cell/BWP/spectrum.

### Concept A

A network node may allocate/schedule/assign/provide/indicate a set of resources for/to a UE (e.g., intermediate UE or UE reader). Preferably in certain embodiments, the set of resources may be utilized by the UE at least for Ambient IoT-related operations/procedures. Preferably in certain embodiments, the set of resources may be utilized at least for one or more R2D transmissions and/or one or more D2R transmissions.

The UE may be scheduled/requested/configured to perform a first UL transmission in a first TTI/occasion. The first UL transmission may be performed in the UL carrier/cell/BWP/spectrum, e.g., in the same UL carrier/cell/BWP/spectrum as the first R2D transmission and/or the second D2R transmission. Preferably in certain embodiments, the first UL transmission may be any of Physical Random Access Channel (PRACH) transmission, PUSCH (re)transmission, Physical Uplink Control Channel (PUCCH) (re)transmission, or Sounding Reference Signal (SRS) transmission.

The Concept A comprises that when the first TTI/occasion is overlapped with the first resource in time domain, the UE may prioritize either performing the first UL transmission or performing the first R2D transmission. The UE may perform the prioritized one among the first UL transmission and the first R2D transmission. The UE may not perform the deprioritized one among the first UL transmission and the first R2D transmission.

The Concept A comprises that when the first TTI/occasion is overlapped with the second resource in time domain, the UE may prioritize either performing the first UL transmission or receiving the second D2R transmission. The UE may perform the prioritized one among the first UL transmission and (receiving) the second D2R transmission. The UE may not perform the deprioritized one among the first UL transmission and (receiving) the second D2R transmission.

If the UE does not receive the second D2R transmission (e.g., due to the second D2R transmission being de-prioritized or the first UL transmission being prioritized), the UE may not know whether the second D2R transmission is successful or not. In this case, the UE may consider the second D2R transmission as failed. The UE may schedule a retransmission of the second D2R transmission. The UE may retransmit an R2D transmission associated with the second D2R transmission (e.g., the R2D transmission requesting/scheduling the second D2R transmission, or another R2D transmission requesting/scheduling the second D2R transmission). The UE may transmit (or provide) a feedback indication. The feedback indication may indicate a Negative Acknowledgement (NACK) (or the second D2R transmission is not received successfully).

The prioritization may be performed at least with a criterion/rule, as any or combinations of the following embodiments:

In one embodiment, the UE may perform the prioritization based on type of the first UL transmission.

Preferably in certain embodiments, if the first UL transmission belongs to a first UL type, the UE prioritizes the first UL transmission (and/or deprioritize the first R2D transmission and/or the second D2R transmission). If the first UL transmission does not belong to the first UL type (e.g., belong to a second UL type), the UE deprioritizes the first UL transmission (and/or prioritize the first R2D transmission and/or the second D2R transmission). If the first UL transmission does not belong to the first UL type (e.g., belong to a second UL type), the UE may not prioritize the first UL transmission.

The first UL type may comprise any of PRACH, PUSCH scheduled by a UL grant in a Random Access Response (RAR) and its retransmission, PUSCH for Type-2 random access procedure and its retransmission, PUSCH (dynamically) scheduled by DCI (e.g., DCI format 0_0/0_1/0_2), PUCCH with Hybrid Automatic Repeat Request (HARQ)-Acknowledgement (ACK) information in response to successRAR, PUCCH indicated by a Downlink Control Information (DCI) format 10 with Cyclic Redundancy Check (CRC) scrambled by a corresponding Temporary Cell Radio Network Temporary Identifier (TC-RNTI), PUCCH with a (positive and/or negative) Scheduling Request (SR), PUCCH with HARQ-ACK information, PUCCH with SL HARQ-ACK information, PUCCH with Sidelink Control Information (CSI) report, PUSCH with aperiodic CSI report, or aperiodic SRS. For instance, the UE may prioritize PRACH over the first R2D transmission and/or the second D2R transmission. For instance, the UE may prioritize PUCCH with SR or HARQ-ACK information over the first R2D transmission and/or the second D2R transmission. For instance, the UE may prioritize the first R2D transmission and/or the second D2R transmission over PUCCH with CSI report. For instance, the UE may prioritize the first R2D transmission and/or the second D2R transmission over PUCCH with CSI report. For instance, the UE may prioritize PUSCH scheduled by a UL grant in RAR over the first R2D transmission and/or the second D2R transmission. For instance, the UE may prioritize the first R2D transmission and/or the second D2R transmission over PUSCH scheduled by a UL grant, e.g., DCI format 0_0/0_1/0_2 (not in RAR). For instance, the UE may prioritize aperiodic SRS over the first R2D transmission and/or the second D2R transmission. For instance, the UE may prioritize the first R2D transmission and/or the second D2R transmission over periodic/semi-persistent SRS. For instance, the UE may prioritize PUSCH with aperiodic CSI report over the first R2D transmission and/or the second D2R transmission. For instance, the UE may prioritize the first R2D transmission and/or the second D2R transmission over periodic/semi-persistent CSI report (in PUSCH or PUSCCH).

The second UL type may comprise any of configured uplink grant for PUSCH, configured uplink grant type 1 (for PUSCH), configured uplink grant type 2 (for PUSCH), PUSCH (dynamically) scheduled by DCI (e.g., DCI format 0_0/0_1/0_2), PUCCH with HARQ-ACK information, PUCCH with SL HARQ-ACK information, periodic CSI report, or periodic SRS. Preferably in certain embodiments, the second UL type may be exclusive from the first UL type.

In one embodiment, the UE may perform the prioritization based on an interface (e.g., Uu interface, A-IoT interface). The UE may (always) prioritize the first UL transmission (and/or deprioritize the first R2D transmission and/or the second D2R transmission). The UE may prioritize transmission(s) on Uu interface (and/or deprioritize transmission(s) on A-IoT interface). The UE may prioritize the first UL transmission(s) over the first R2D transmission and/or the second D2R transmission (e.g., transmission(s) on A-IoT interface). Alternatively, the UE may (always) deprioritize the first UL transmission (and/or prioritize the first R2D transmission and/or the second D2R transmission). The UE may deprioritize transmission(s) on the Uu interface (and/or prioritize transmission(s) on the A-IoT interface). The UE may prioritize the first R2D transmission and/or the second D2R transmission (e.g., transmission(s) on A-IoT interface) over the first UL transmission(s).

In one embodiment, the UE may perform the prioritization based on an indication and/or configuration. The indication and/or configuration may be dynamically indicated by the Network (NW). The prioritization may be dynamically indicated by the NW. The indication and/or configuration may be configured and/or reconfigured by the NW. Preferably in certain embodiments, the UE may be indicated/configured by the NW to prioritize the first UL transmission (and/or deprioritize the first R2D transmission and/or the second D2R transmission). The UE may be indicated/configured by the NW to prioritize the first R2D transmission and/or the second D2R transmission (and/or deprioritize the first UL transmission). For example, if the UE receives the indication (or configuration), the UE may perform the prioritization (or de-prioritization), e.g., based on the indication (or configuration). If the UE does not receive the indication (or configuration), the UE may not perform the prioritization (or de-prioritization). Preferably in certain embodiments, or alternatively, if the UE does not receive the indication (or configuration), the UE may perform the prioritization (or de-prioritization) based on other embodiment(s).

In one embodiment, the UE may perform the prioritization based on a priority associated with the first UL transmission. The priority with a smaller value may have higher priority (e.g., priority 0 is the highest priority).

Preferably in certain embodiments, if the priority associated with the first UL transmission is higher than a priority associated with the first R2D transmission and/or a priority associated with the second D2R transmission, the UE prioritizes the first UL transmission (and deprioritize the first R2D transmission and/or the second D2R transmission). If the priority associated with the first UL transmission is lower than the priority associated with the first R2D transmission and/or the priority associated with the second D2R transmission, the UE deprioritizes the first UL transmission (and prioritize the first R2D transmission and/or the second D2R transmission).

Preferably in certain embodiments, the UE may be configured with a first priority threshold. If the priority associated with the first UL transmission is higher (or lower) than the first priority threshold (e.g., a priority value associated with the first UL transmission is smaller (or larger) than the first priority threshold), the UE prioritizes the first UL transmission (and deprioritize the first R2D transmission and/or the second D2R transmission). If the priority associated with the first UL transmission is lower (or higher) than the first priority threshold (e.g., the priority value associated with the first UL transmission is larger (or smaller) than the first priority threshold), the UE deprioritizes the first UL transmission (and prioritize the first R2D transmission and/or the second D2R transmission).

Preferably in certain embodiments, (for any of embodiments,) when D2R resource(s) or R2D resource(s) in the first TTI/occasion is expected or predicted to be deprioritized (e.g., based on the above reason(s)/rule(s)), the UE does not schedule the D2R resource(s) or R2D resource(s) to Ambient IoT device(s).

### Concept B

A network node may allocate/schedule/assign/provide/indicate a set of resources for/to a UE (e.g., intermediate UE or UE reader). Preferably in certain embodiments, the set of resources may be utilized by the UE at least for Ambient IoT-related operations/procedures. Preferably in certain embodiments, the set of resources may be utilized at least for one or more R2D transmissions and/or one or more D2R transmissions.

The UE may utilize the set of resources for performing Ambient IoT-related operations/procedures. The UE may trigger/request to perform one or more operations/procedures or detect/determine one or more conditions, e.g., in Uu interface.

Preferably in certain embodiments, when the UE triggers/requests to perform a first operation/procedure or detects/determines a first condition, the UE may stop/suspend utilizing the set of resources for performing Ambient IoT-related operations/procedures. Preferably in certain embodiments, when the UE triggers/requests to perform the first operation/procedure or detects/determines the first condition, the UE may stop/suspend performing Ambient IoT-related operations/procedures or stop/suspend (utilizing) the set of resources. Alternatively, when the UE triggers/requests to perform the first operation/procedure or detects/determines the first condition, the UE may release/clear the set of resources (i.e., not performing Ambient IoT-related operations/procedures with the set of resources).

The UE may request or resume a/the set of resources for performing Ambient IoT-related operations/procedures based on at least occurrence or completion of the first operation/procedure, or detection/determination of the first condition.

Preferably in certain embodiments, the first operation/procedure may be triggered/requested in a first timing overlapped with the set of resources in time domain. Preferably in certain embodiments, the first operation/procedure may be triggered/requested in the first timing within the (consecutive/continuous) time duration/period of the set of resources. Preferably in certain embodiments, the first operation/procedure may be triggered/requested in the first timing within consecutive/continuous TTIs of the set of resources. Preferably and/or alternatively in certain embodiments, the first condition may be detected/determined in a first timing overlapped with the set of resources in time domain. Preferably in certain embodiments, the first condition may be detected/determined in the first timing within the (consecutive/continuous) time duration/period of the set of resources. Preferably in certain embodiments, the first condition may be detected/determined in the first timing within consecutive/continuous TTIs of the set of resources.

Preferably in certain embodiments, after the first operation/procedure is completed/finished or after the first condition is solved/recovered, the UE may resume/recover performing Ambient IoT-related operations/procedures. Preferably in certain embodiments, after the first operation/procedure is completed/finished or after the first condition is solved/recovered, the UE may resume/recover utilizing the set of resources for performing Ambient IoT-related operations/procedures.

Preferably and/or alternatively in certain embodiments, if the first operation/procedure is completed/finished within a first time duration or before a first specific timing or if the first condition is solved/recovered within a first time duration or before a first specific timing, the UE may resume/recover (utilizing the set of resources for) performing Ambient IoT-related operations/procedures. Preferably and/or alternatively in certain embodiments, if the first operation/procedure is completed/finished outside the first time duration or after the first specific timing or if the first condition is solved/recovered outside the first time duration or after the first specific timing, the UE may not resume/recover (utilizing the set of resources for) performing Ambient IoT-related operations/procedures, e.g., the UE may release/clear the set of resources (i.e., not performing Ambient IoT-related operations/procedures with the set of resources). Preferably and/or alternatively in certain embodiments, if the first operation/procedure is not completed/finished at/after ending time of the first time duration or at/after the first specific timing or if the first condition is not solved/recovered at/after ending time of the first time duration or at/after the first specific timing, the UE may not resume/recover (utilizing the set of resources for) performing Ambient IoT-related operations/procedures, e.g., the UE may release/clear the set of resources (i.e., not performing Ambient IoT-related operations/procedures with the set of resources). Preferably in certain embodiments, the first time duration or the first specific timing may be derived/determined based on the first timing. Preferably in certain embodiments, the first time duration or the first specific timing may be derived/determined with reference on the first timing. Preferably in certain embodiments, time length of the first duration may be configured or specified. Preferably in certain embodiments, the first time duration may be counted via a first timer. The first timer may start/restart in the first timing. If the first timer is running when the first operation/procedure is completed/finished or the first condition is solved/recovered, the UE may resume/recover (utilizing the set of resources for) performing Ambient IoT-related operations/procedures. Preferably and/or alternatively in certain embodiments, if the first timer has expired when the first operation/procedure is completed/finished or the first condition is solved/recovered, the UE may not resume/recover (utilizing the set of resources for) performing Ambient IoT-related operations/procedures, e.g., the UE may release/clear the set of resources (i.e., not performing Ambient IoT-related operations/procedures with the set of resources). Preferably and/or alternatively in certain embodiments, if the first timer expires and the first operation/procedure is not completed/finished or the first condition is not solved/recovered, the UE may not resume/recover (utilizing the set of resources for) performing Ambient IoT-related operations/procedures, e.g., the UE may release/clear the set of resources (i.e., not performing Ambient IoT-related operations/procedures with the set of resources).

Preferably in certain embodiments, the first condition may be/comprise a physical layer problem (for the carrier/cell). The physical layer problem may be detected/determined at least upon receiving a number (e.g., N310) of consecutive “out-of-sync” indications for the cell/carrier. In response to the physical layer problem, the UE may start a timer, e.g., timer T310. The physical layer problem may be solved/recovered at least upon receiving a number (e.g., N311) of consecutive “in-sync” indications for the cell/carrier. Preferably in certain embodiments, when or during the UE solves/recovers the physical layer problem or under physical layer problem, the UE may stop/suspend performing ambient IoT-related operation/procedures or stop/suspend (utilizing) the set of resources. The UE may start/restart/resume/continue performing ambient the IoT-related operation/procedure or resume/continue (utilizing) the set of resources after solving/recovering the physical layer problem.

Preferably in certain embodiments, the first condition may be/comprise an RLF (for the carrier/cell). The radio link failure may be triggered/requested at least when the timer T310 expires. The radio link failure may be triggered/requested at least when a random access problem occurs. The radio link failure may be solved/recovered at least upon receiving a number (e.g., N311) of consecutive “in-sync” indications for the cell/carrier. Preferably in certain embodiments, when or during the UE solves/recovers the RLF or under the RLF, the UE may stop/suspend performing ambient IoT-related operations/procedures or stop/suspend (utilizing) the set of resources. The UE may start/restart/resume/continue performing the ambient IoT-related operation/procedure or resume/continue (utilizing) the set of resources after solving/recovering the RLF.

Preferably in certain embodiments, the first operation/procedure may be/comprise a Handover (HO) procedure. The handover procedure may be triggered/requested via receiving handover command (from source cell/gNB) or by the UE itself. The handover procedure may be a Conditional Handover (CHO). The handover procedure may be completed/finished when the UE transmits a complete message, e.g., RRCReconfigurationComplete message (to target cell/gNB). Preferably in certain embodiments, when or during the UE performs the handover, the UE may stop/suspend performing ambient IoT-related operations/procedures or stop/suspend (utilizing) the set of resources. The UE may start/restart/resume/continue performing the ambient IoT-related operation/procedure or resume/continue (utilizing) the set of resources after performing (part of or entire) the handover.

Preferably in certain embodiments, the first operation/procedure may be/comprise Layer 1 (L1)/Layer 2 (L2) Triggered Mobility (LTM) procedure. The LTM procedure may be triggered/requested via receiving an LTM cell switch command (from source cell/gNB) or by the UE itself. The LTM procedure may be completed/finished when the UE transmits a complete message, e.g., RRCReconfgurationComplete message (to target cell/gNB). Preferably in certain embodiments, when or during the UE performs the LTM procedure, the UE may stop/suspend performing ambient IoT-related operations/procedures or stop/suspend (utilizing) the set of resources. The UE may start/restart/resume/continue performing the ambient IoT-related operation/procedure or resume/continue (utilizing) the set of resources after performing the (part of or entire) LTM procedure.

Preferably in certain embodiments, the first operation/procedure may be/comprise a random access procedure (in the carrier/cell). Preferably in certain embodiments, the first operation may comprise any of Msg1/PRACH transmission, Msg2 reception/monitoring, Msg3 transmission, PUSCH scheduled by an UL grant in a RAR, and/or Msg4 reception/monitoring (of the random access procedure). Preferably in certain embodiments, the random access procedure may be triggered/requested by the UE. Preferably in certain embodiments, the random access procedure may be triggered/requested by the network node. Preferably in certain embodiments, the random access procedure may be triggered/requested when the UE receives a PDCCH order. Preferably in certain embodiments, the random access procedure may be a contention-based random access procedure. The random access procedure may be completed/finished when the UE receives a corresponding Message 4 (Msg4). Preferably and/or alternatively in certain embodiments, the random access procedure may be a contention-free random access procedure. The random access procedure may be completed/finished when the UE receives a corresponding Msg2. Preferably in certain embodiments, when or during the UE performs the random access procedure, the UE may stop/suspend performing ambient IoT-related operation/procedures or stop/suspend (utilizing) the set of resources. The UE may start/restart/resume/continue performing ambient IoT-related operation/procedure or resume/continue (utilizing) the set of resources after performing the (part of or entire) random access procedure. Preferably in certain embodiments, the first condition may be/comprise a Timing Advance (TA) timer (e.g., timeAlignmentTimer) expiry/expiration (for the carrier/cell). Preferably in certain embodiments, the first condition may be/comprise a failure of UL time alignment (for the carrier/cell). The uplink timing out of sync may be solved/recovered at least upon receiving a Timing Advance Command (TAC). Preferably in certain embodiments, when the TA timer expires, the UE may flush/release/clear the set of resources (for performing Ambient IoT-related operations/procedures). Preferably in certain embodiments, when or during the UE solves/recovers the timing advance or before the timing advance timer (re)starts, the UE may stop/suspend performing ambient IoT-related operations/procedures or stop/suspend (utilizing) the set of resources. The UE may start/restart/resume/continue performing the ambient IoT-related operation/procedure or resume/continue (utilizing) the set of resources, after the UE solves/recovers the timing advance or after the timing advance timer (re)starts.

Preferably in certain embodiments, the first operation/procedure may be/comprise a beam failure recovery procedure or link recovery procedure (for the carrier/cell). Preferably in certain embodiments, the first condition may be/comprise a beam failure (for the carrier/cell). Preferably in certain embodiments, the beam failure recovery procedure or the link recovery procedure may be triggered/requested when the beam failure is detected/determined. Preferably in certain embodiments, when or during the UE performs the beam failure recovery procedure, the UE may stop/suspend performing ambient IoT-related operations/procedures or stop/suspend (utilizing) the set of resources. The UE may start/restart/resume/continue performing the ambient IoT-related operation/procedure or resume/continue (utilizing) the set of resources after performing the (part of or entire) beam failure recovery procedure. Alternatively and/or preferably in certain embodiments, when the UE triggers/requests to perform a second operation/procedure or detects/determines a second condition, the UE may perform the second operation/procedure and keep utilizing the set of resources for performing Ambient IoT-related operations/procedures. Preferably in certain embodiments, if a UL transmission or a DL reception of the second operation/procedure collides with the first R2D transmission and/or the second D2R transmission, the UE may perform either one based on Concept A.

Preferably in certain embodiments, the second operation/procedure may be triggered/requested in a second timing overlapped with the set of resources in time domain. Preferably in certain embodiments, the second operation/procedure may be triggered/requested in the second timing within the (consecutive/continuous) time duration/period of the set of resources. Preferably in certain embodiments, the second operation/procedure may be triggered/requested in the second timing within consecutive/continuous TTIs of the set of resources. Preferably and/or alternatively in certain embodiments, the second condition may be detected/determined in a second timing overlapped with the set of resources in time domain. Preferably in certain embodiments, the second condition may be detected/determined in the second timing within the (consecutive/continuous) time duration/period of the set of resources. Preferably in certain embodiments, the second condition may be detected/determined in the second timing within consecutive/continuous TTIs of the set of resources.

Preferably and/or alternatively in certain embodiments, if the second operation/procedure is not completed/finished at/after ending time of a second time duration or at/after a second specific timing or if the second condition is not solved/recovered at/after ending time of the second time duration or at/after the second specific timing, the UE may release/clear the set of resources (i.e., not performing Ambient IoT-related operations/procedures with the set of resources). Preferably in certain embodiments, the second time duration or the second specific timing may be derived/determined based on the second timing. Preferably in certain embodiments, the second time duration or the second specific timing may be derived/determined with reference on the second timing. Preferably in certain embodiments, a time length of the second duration may be configured or specified. Preferably in certain embodiments, the second time duration may be counted via a second timer. The second timer may start/restart in the second timing. Preferably in certain embodiments, if the second timer expires and the second operation/procedure is not completed/finished or the second condition is not solved/recovered, the UE may release/clear the set of resources (i.e., not performing Ambient IoT-related operations/procedures with the set of resources).

Preferably and/or alternatively in certain embodiments, if the second operation/procedure is completed/finished (e.g., before the ending time of the second time duration or before the second specific timing) or if the second condition is solved/recovered (e.g., before the ending time of the second time duration or before the second specific timing), the UE may not (need to) stop/suspend the ambient IoT-related operation/procedure.

Preferably in certain embodiments, the second condition may be/comprise a physical layer problem (for the carrier/cell). The physical layer problem may be detected/determined at least upon receiving a number (e.g., N310) of consecutive “out-of-sync” indications for the cell/carrier. In response to the physical layer problem, the UE may start a timer, e.g., timer T310. The physical layer problem may be solved/recovered at least upon receiving a number (e.g., N311) of consecutive “in-sync” indications for the cell/carrier. Preferably in certain embodiments, when or during the UE solves/recovers the physical layer problem or under physical layer problem, the UE may keep utilizing the set of resources for performing Ambient IoT-related operations/procedures.

Preferably in certain embodiments, the second condition may be/comprise an RLF (for the carrier/cell). The radio link failure may be triggered/requested at least when the timer T310 expires. The radio link failure may be triggered/requested at least when a random access problem occurs. The radio link failure may be solved/recovered at least upon receiving a number (e.g, N311) of consecutive “in-sync” indications for the cell/carrier. Preferably in certain embodiments, when or during the UE solves/recovers the RLF or under the RLF, the UE may keep utilizing the set of resources for performing Ambient IoT-related operations/procedures.

Preferably in certain embodiments, the second operation/procedure may be/comprise a Handover procedure. The handover procedure may be triggered/requested via receiving handover command (from source cell/gNB) or by the UE itself. The handover procedure may be a CHO. The handover procedure may be completed/finished when the UE transmits a complete message, e.g., RRCReconfgurationComplete message (to target cell/gNB). Preferably in certain embodiments, when or during the UE performs the handover, the UE may keep utilizing the set of resources for performing Ambient IoT-related operations/procedures.

Preferably in certain embodiments, the second operation/procedure may be/comprise an LTM procedure. The LTM procedure may be triggered/requested via receiving an LTM cell switch command (from source cell/gNB) or by the UE itself. The LTM procedure may be completed/finished when the UE transmits a complete message, e.g., RRCReconfigurationComplete message (to target cell/gNB). Preferably in certain embodiments, when or during the UE performs the LTM procedure, the UE may keep utilizing the set of resources for performing Ambient IoT-related operations/procedures.

Preferably in certain embodiments, the second operation/procedure may be/comprise a random access procedure (in the carrier/cell). Preferably in certain embodiments, the first operation may comprise any of Msg1/PRACH transmission, Msg2 reception/monitoring, Msg3 transmission, PUSCH scheduled by a UL grant in a RAR, and/or Msg4 reception/monitoring (of the random access procedure). Preferably in certain embodiments, the random access procedure may be triggered/requested by the UE. Preferably in certain embodiments, the random access procedure may be triggered/requested by the network node. Preferably in certain embodiments, the random access procedure may be triggered/requested when the UE receives a PDCCH order. Preferably in certain embodiments, the random access procedure may be a contention-based random access procedure. The random access procedure may be completed/finished when the UE receives a corresponding Msg4. Preferably and/or alternatively in certain embodiments, the random access procedure may be a contention-free random access procedure. The random access procedure may be completed/finished when the UE receives a corresponding Msg2. Preferably in certain embodiments, when or during the UE performs the random access procedure, the UE may keep utilizing the set of resources for performing Ambient IoT-related operations/procedures.

Preferably in certain embodiments, the second condition may be/comprise a TA timer (e.g., timeAlignmentTimer) expiry (for the carrier/cell). Preferably in certain embodiments, the second condition may be/comprise failure of a UL time alignment (for the carrier/cell). The uplink timing out of sync may be solved/recovered at least upon receiving a Timing Advance Command. Preferably in certain embodiments, when the TA timer expires, the UE may not flush/release/clear the set of resources (for performing Ambient IoT-related operations/procedures). Preferably in certain embodiments, when or during the UE solves/recovers the timing advance or before the timing advance timer (re)starts, the UE may keep utilizing the set of resources for performing Ambient IoT-related operations/procedures.

Preferably in certain embodiments, the second operation/procedure may be/comprise a beam failure recovery procedure or link recovery procedure (for the carrier/cell). Preferably in certain embodiments, the second condition may be/comprise a beam failure (for the carrier/cell). Preferably in certain embodiments, the beam failure recovery procedure or the link recovery procedure may be triggered/requested when a beam failure is detected/determined. Preferably in certain embodiments, when or during the UE performs the beam failure recovery procedure, the UE may keep utilizing the set of resources for performing Ambient IoT-related operations/procedures.

Preferably in certain embodiments, handling between the set of resources and the first operation/procedure/condition is different from handling between the set of resources and the second operation/procedure/condition. Preferably in certain embodiments, the first operation/procedure may be different/exclusive from the second operation/procedure. Preferably in certain embodiments, the first condition may be different/exclusive from the second condition.

Preferably in certain embodiments, for two operations/procedures/conditions (e.g., the two are/belong to the first operations/procedures/conditions, or the two are/belong to the second operations/procedures/conditions), the UE may perform similar/same handling between the set of resources and each operation/procedure/condition. Preferably in certain embodiments, for two operations/procedures/conditions (e.g., one is/belongs to the first operation/procedure/condition, and another one is/belongs to the second operation/procedure/condition), the UE may perform different handlings between the set of resources and each operation/procedure/condition.

### Concept C

A network node may allocate/schedule/assign/provide/indicate a set of resources for/to a UE (e.g., intermediate UE or UE reader). Preferably in certain embodiments, the set of resources may be utilized by the UE at least for Ambient IoT-related operations/procedures. Preferably in certain embodiments, the set of resources may be utilized at least for one or more R2D transmissions and/or one or more D2R transmissions.

Preferably in certain embodiments, the UE may derive/determine the (available/usable) set of resources based on the resource allocation/assignment/configuration and one or more specific time occasions, e.g., one or more time occasions of one or more types of transmissions. Preferably in certain embodiments, the (available/usable) set of resources may be utilized by the UE at least for Ambient IoT-related operations/procedures. Preferably in certain embodiments, the UE may derive/determine the (available/usable) set of resources in response to receiving resource allocation/assignment/configuration, obtaining information of the one or more time occasions, and/or before performing the Ambient IoT-related operations/procedures.

Preferably in certain embodiments, the UE may derive/determine the set of resources based on (resource allocation/assignment/configuration in) the one or more DL signalings. Preferably in certain embodiments, the UE may determine one or more R2D transmissions and/or scheduling of one or more D2R transmissions within the set of resources, wherein the determination of the one or more R2D transmission and/or scheduling of the one or more D2R transmission excludes the one or more specific time occasions, e.g., the one or more time occasions of one or more types of transmissions. Preferably in certain embodiments, the UE may determine one or more R2D transmissions and/or scheduling of one or more D2R transmissions within the set of resources, wherein the determined one or more R2D transmission and/or the scheduled one or more D2R transmission shall avoid overlapping (in time domain) with the one or more specific time occasions, e.g., the one or more time occasions of one or more types of transmissions. Preferably in certain embodiments, the UE may derive/determine/check the one or more time occasions before determining the one or more R2D transmissions and/or scheduling of the one or more D2R transmissions.

Preferably in certain embodiments, (the resource allocation/assignment/configuration in) the one or more DL signalings may indicate a starting timing and/or a number of (consecutive/continuous) TTIs for the set of resources. Preferably in certain embodiments, (the resource allocation/assignment/configuration in) the one or more DL signalings may indicate a starting timing and/or a (consecutive/continuous) time duration/period for the set of resources. Preferably in certain embodiments, (the resource allocation/assignment/configuration in) the one or more DL signalings may indicate a starting timing for the set of resources, and a deactivation/release signaling (from the network node to the UE) may indicate an ending timing for the set of resources.

The Concept C comprises that for determining/deriving the (available/usable) set of resources or for the determination of the one or more R2D transmissions and/or scheduling of the one or more D2R transmissions, the UE may exclude the one or more time occasions of the one or more types of transmissions. Preferably in certain embodiments, for determining/deriving the (available/usable) set of resources or for the determination of the one or more R2D transmissions and/or scheduling of the one or more D2R transmissions, the UE may exclude the one or more time occasions of the one or more types of transmissions from the number of (consecutive/continuous) TTIs. Preferably in certain embodiments, for determining/deriving the (available/usable) set of resources or for the determination of the one or more R2D transmissions and/or scheduling of the one or more D2R transmissions, the UE may exclude the one or more time occasions of the one or more types of transmissions from (consecutive/continuous) time duration/period. Preferably in certain embodiments, for determining/deriving the (available/usable) set of resources or for the determination of the one or more R2D transmissions and/or scheduling of the one or more D2R transmissions, the UE may exclude the one or more time occasions of the one or more types of transmissions before the ending timing (and after the starting timing). Preferably in certain embodiments, for determining/deriving the (available/usable) set of resources or for the determination of the one or more R2D transmissions and/or scheduling of the one or more D2R transmissions, the UE may exclude the one or more time occasions of the one or more types of transmissions between the starting timing and the ending timing. Preferably in certain embodiments, the determined/derived (available/usable) set of resources may not be continuous in time domain. Preferably in certain embodiments, the UE may perform the exclusion when determining/deriving the (available/usable) set of resources or when the UE determines the one or more R2D transmissions and/or scheduling of the one or more D2R transmissions. The UE may not schedule (or receive) a D2R transmission (e.g., the second D2R transmission) (and/or transmit an R2D transmission, e.g., the first R2D transmission) on the excluded resource(s) and/or time occasion(s). The UE may be not allowed to schedule (or receive) a D2R transmission (e.g., the second D2R transmission) (and/or transmit an R2D transmission, e.g., the first R2D transmission) on the excluded resource(s) and/or time occasion(s). The UE may be prohibited to schedule (or receive) a D2R transmission (e.g., the second D2R transmission) (and/or transmit an R2D transmission, e.g., the first R2D transmission) on the excluded resource(s) and/or time occasion(s).

Preferably in certain embodiments, for determining/deriving the (available/usable) set of resources or for the determination of the one or more R2D transmissions and/or scheduling of the one or more D2R transmissions, the UE may not exclude time occasions of a transmission other than the one or more types of transmissions. Preferably in certain embodiments, for determining/deriving the (available/usable) set of resources or for the determination of the one or more R2D transmissions and/or scheduling of the one or more D2R transmissions, the UE may not exclude time occasions of a transmission not belonging to the one or more types of transmissions.

Preferably in certain embodiments, the one or more specific time occasions may be interchangeable with the one or more time occasions of one or more types of transmissions. The one or more types of transmissions may comprise the first DL type of DL transmission, as described in Concept A. It may mean the Concept C and the Concept A may be exclusive or alternative methods/embodiments for the first DL type of DL transmission.

The first DL type may comprise any of PDCCH, PDCCH in CORESET with index 0, PDCCH in Type0-PDCCH CSS set, PDCCH in Type1-PDCCH CSS set, PDCCH in Type1A-PDCCH CSS set, PDCCH in Type2-PDCCH CSS set, PDCCH in Type2A-PDCCH CSS set, PDCCH in Type3-PDCCH CSS set, PDCCH in CSS set, PDSCH scheduled by a DCI format with CRC scrambled by RA-RNTI, PDSCH scheduled by a DCI format with CRC scrambled by MsgB-RNTI, PDSCH scheduled by a DCI format with CRC scrambled by TC-RNTI, PDSCH scheduled by a DCI format with CRC scrambled by P-RNTI, PDSCH scheduled by a DCI format with CRC scrambled by SI-RNTI, PDSCH scheduled by a DCI format with CRC scrambled by Slot Format Indicator (SFI)-RNTI, PDSCH scheduled by a DCI format with CRC scrambled by CS-RNTI, SS/PBCH block, configured/periodic CSI-RS, or aperiodic CSI-RS.

Preferably and/or alternatively in certain embodiments, the one or more types of transmissions may comprise the first UL type of UL transmission, as described in Concept A. It may mean the Concept C and the Concept A may be exclusive or alternative methods/embodiments for the first UL type of UL transmission.

The first UL type may comprise any of PRACH, PUSCH scheduled by a UL grant in a RAR and its retransmission, PUSCH for Type-2 random access procedure and its retransmission, PUSCH (dynamically) scheduled by DCI (e.g., DCI format 0_0/0_1/0_2), PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS.

Preferably and/or alternatively in certain embodiments, the one or more types of transmissions may comprise the second UL type of UL transmission, as described in Concept A. The second UL type may comprise any of configured uplink grant for PUSCH, configured uplink grant type 1 (for PUSCH), configured uplink grant type 2 (for PUSCH), PUSCH (dynamically) scheduled by DCI (e.g., DCI format 0_0/0_1/0_2), PUCCH with HARQ-ACK information, PUCCH with SL HARQ-ACK information, periodic CSI report, or periodic SRS.

Alternatively and/or preferably in certain embodiments, the one or more types of transmissions may comprise a third DL type of DL transmissions. The third DL type of DL transmissions are different/exclusive from the first DL type of DL transmission. It may mean the Concept C and the Concept A may be co-existed (e.g., not exclusive) methods/embodiments (e.g., from aspect of DL transmission). Preferably in certain embodiments, the third DL type may comprise any of PDCCH, PDCCH in CORESET with index 0, PDCCH in Type0-PDCCH CSS set, PDCCH in Type1-PDCCH CSS set, PDCCH in Type1A-PDCCH CSS set, PDCCH in Type2-PDCCH CSS set, PDCCH in Type2A-PDCCH CSS set, PDCCH in Type3-PDCCH CSS set, PDCCH in CSS set, PDSCH scheduled by a DCI format with CRC scrambled by RA-RNTI, PDSCH scheduled by a DCI format with CRC scrambled by MsgB-RNTI, PDSCH scheduled by a DCI format with CRC scrambled by TC-RNTI, PDSCH scheduled by a DCI format with CRC scrambled by P-RNTI, PDSCH scheduled by a DCI format with CRC scrambled by SI-RNTI, PDSCH scheduled by a DCI format with CRC scrambled by SFI-RNTI, PDSCH scheduled by a DCI format with CRC scrambled by CS-RNTI, SS/PBCH block, or aperiodic CSI-RS.

Alternatively and/or preferably in certain embodiments, the one or more types of transmissions may comprise a third UL type of UL transmissions. The third UL type of UL transmissions are different/exclusive from the first UL type of UL transmission. It may mean the Concept C and the Concept A may be co-existed (e.g., not exclusive) methods/embodiments (e.g., from aspect of UL transmission). Preferably in certain embodiments, the third UL type may comprise any of PRACH, PUSCH scheduled by a UL grant in a RAR and its retransmission, PUSCH for Type-2 random access procedure and its retransmission, PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS.

### Concept D

The Concept D comprises that when the UE receives the one or more DL signalings from a network node, the UE may derive/determine one or more candidate (UL) resources among/from the set of resources. Preferably in certain embodiments, the set of resources may be utilized by the UE at least for Ambient IoT-related operations/procedures.

Preferably in certain embodiments, (the resource allocation/assignment/configuration in) the one or more DL signalings may indicate a starting timing and/or a number of (consecutive/continuous) TTIs for the set of resources. Preferably in certain embodiments, (the resource allocation/assignment/configuration in) the one or more DL signalings may indicate a starting timing and/or a (consecutive/continuous) time duration/period for the set of resources. Preferably in certain embodiments, (the resource allocation/assignment/configuration in) the one or more DL signalings may indicate a starting timing for the set of resources, and a deactivation/release signaling (from the network node to the UE) may indicate an ending timing for the set of resources.

Preferably in certain embodiments, when the UE is triggered/requested to transmit a specific message/signaling, the UE may perform a specific UL transmission for (transmitting/indicating) the specific message/signaling, e.g., in one (candidate) UL resource of the one or more candidate (UL) resources.

Preferably in certain embodiments, if the UE is not (yet) triggered/requested to transmit the specific message/signaling, the UE may not derive/determine the one or more candidate (UL) resources among/from the set of resources. Preferably in certain embodiments, if the UE is not (yet) triggered/requested to transmit the specific message/signaling, the one or more candidate (UL) resources are (considered to be) utilized for Ambient IoT-related operations/procedures.

Preferably in certain embodiments, the specific message/signaling may be/comprise a report/indication/feedback of Ambient IoT-related operations/procedures/resources (e.g., from the UE to the network node or to the Core Network). Preferably in certain embodiments, the specific message/signaling may be/comprise an inventory/query report (of Ambient IoT devices). Preferably in certain embodiments, the inventory/query report may comprise information of which devices are inventoried/queried and/or information of which devices are not inventoried/queried. Preferably in certain embodiments, the specific message/signaling may be/comprise report/information/data which are acquired/received from Ambient IoT devices. Preferably in certain embodiments, the specific message/signaling may be/comprise a status report/feedback (e.g., of Ambient IoT devices, of A-IoT resources).

Preferably in certain embodiments, the specific message/signaling may be/comprise a report/indication/feedback of utilization of the set of resources. Preferably in certain embodiments, the specific message/signaling may be/comprise a resource request for Ambient IoT-related operations/procedures (e.g., to request more resources). Preferably in certain embodiments, the specific message/signaling may be/comprise a release/deactivation request of the set of resources (e.g., to indicate unused resources) (e.g., when the UE completes/finishes the Ambient IoT-related operations/procedures and/or when the UE terminates/stops the Ambient IoT-related operations/procedures).

Preferably in certain embodiments, the specific message/signaling may be/comprise a report/indication/feedback of finishing/completeness of the Ambient IoT-related operations/procedures. Preferably in certain embodiments, the specific message/signaling may be/comprise a report/indication/feedback of termination and/or termination cause of the Ambient IoT-related operations/procedures. Preferably in certain embodiments, the specific message/signaling may be/comprise a report/indication/feedback of suspension/stop of the Ambient IoT-related operations/procedures.

Preferably in certain embodiments, the specific message/signaling may be/comprise a buffer status report for Ambient IoT-related data. Preferably in certain embodiments, the specific message/signaling may be/comprise a report of amount/number of Ambient IoT-related data/information. Preferably in certain embodiments, the Ambient IoT-related data/information may comprise any of the report/indication/feedback of Ambient IoT-related operations/procedures, the inventory/query report, the information of which devices are inventoried/queried and/or information of which devices are not inventoried/queried, the report/information/data which are acquired/received from Ambient IoT devices, the status report/feedback (of Ambient IoT devices), the report/indication/feedback of utilization of the set of resources, the resource request for Ambient IoT-related operations/procedures (e.g., request more resources), the release/deactivation request of the set of resources, the report/indication/feedback of finishing/completeness of the Ambient IoT-related operations/procedures, the report/indication/feedback of termination and/or termination cause of the Ambient IoT-related operations/procedures, or the report/indication/feedback of suspension/stop of the Ambient IoT-related operations/procedures.

Preferably in certain embodiments, the specific message/signaling may be triggered/requested in response that the UE receives the deactivation/release signaling. Preferably in certain embodiments, the specific message/signaling may be triggered/requested in response to finishing/completeness of the Ambient IoT-related operations/procedures. Preferably in certain embodiments, the specific message/signaling may be triggered/requested in response to termination of the Ambient IoT-related operations/procedures. Preferably in certain embodiments, the specific message/signaling may be triggered/requested in response to suspension/stop of the Ambient IoT-related operations/procedures. Preferably in certain embodiments, the specific message/signaling may be triggered/requested in response to suspension/stop of the Ambient IoT-related operations/procedures. Preferably in certain embodiments, the specific message/signaling may be triggered/requested based on a timing/periodicity (e.g., the UE may send the specific message/signaling after initiating an RA procedure for the timing (one time or periodically)). Preferably in certain embodiments, the specific message/signaling may be triggered/requested based on an amount/number of Ambient IoT-related data (e.g., the UE may send the specific message/signaling after receiving a specific number of device data from D2R reception).

Preferably in certain embodiments, the one or more candidate (UL) resources are periodic resources in time domain. Preferably in certain embodiments, the one or more candidate (UL) resources may be separated with a periodicity. The UE may derive/determine the one or more candidate (UL) resources based on a periodicity and/or a time offset. Preferably in certain embodiments, the periodicity and/or the time offset may be indicated/provided/configured by the one or more DL signalings from network node. Preferably in certain embodiments, the periodicity and/or the time offset may be specified.

Preferably in certain embodiments, the one or more candidate (UL) resources may be located in a last one or more TTIs/occasions of the number of (consecutive/continuous) TTIs for the set of resources. Preferably in certain embodiments, the UE may derive/determine the last one or more TTIs/occasions of the number of (consecutive/continuous) TTIs as the one or more candidate (UL) resources. Preferably in certain embodiments, the one or more candidate (UL) resources may be located in last one or more TTIs/occasions of the (consecutive/continuous) time duration/period for the set of resources. Preferably in certain embodiments, the UE may derive/determine the last one or more TTIs/occasions of the (consecutive/continuous) time duration/period as the one or more candidate (UL) resources.

Preferably in certain embodiments, the one or more candidate (UL) resources are comprised, in frequency domain, by the set of resources. Preferably in certain embodiments, the set of resources may comprise/occupy a set of frequency resources, e.g., with the number of (consecutive/continuous) TTIs or within the (consecutive/continuous) time duration/period. Preferably in certain embodiments, the one or more candidate (UL) resources may comprise/occupy all the set of the frequency resources in frequency domain. Preferably and/or alternatively in certain embodiments, the one or more candidate (UL) resources may comprise/occupy part of the set of the frequency resources in frequency domain. Preferably in certain embodiments, frequency-domain resources of the one or more candidate (UL) resources may be indicated/provided/configured by the one or more DL signalings from the network node. Preferably in certain embodiments, the frequency-domain resources of the one or more candidate (UL) resources may be specified.

Preferably in certain embodiments, the one (candidate) UL resource (utilized for the specific UL transmission) may be the most recent one among the one or more candidate (UL) resources when/after the UE is triggered/requested to transmit the specific message/signaling. Preferably in certain embodiments, the one (candidate) UL resource (utilized for the specific UL transmission) may be the most recent one among the one or more candidate (UL) resources when/after a time gap (e.g., time gap for processing) plus triggering/requesting timing of the specific message/signaling.

Preferably in certain embodiments, the one (candidate) UL resource (utilized for the specific UL transmission) may be/comprise the last one, in time domain, among the one or more candidate (UL) resources. Preferably in certain embodiments, the one (candidate) UL resource (utilized for the specific UL transmission) may be/comprise the last TTI, in time domain, among the set of resources. Preferably in certain embodiments, the one (candidate) UL resource (utilized for the specific UL transmission) may be/comprise the last one or more symbols, in time domain, among the set of resources. Preferably in certain embodiments, the one (candidate) UL resource (utilized for the specific UL transmission) may be the last one resource among the set of resources.

Preferably and/or alternatively in certain embodiments, when the UE receives the deactivation/release signaling, the UE may perform the specific UL transmission for (transmitting/indicating) the specific message/signaling in one UL resource indicated/scheduled by the deactivation/release signaling. Preferably in certain embodiments, when the UE receives the deactivation/release signaling, the one (candidate) UL resource (utilized for the specific UL transmission) may be indicated/scheduled by the deactivation/release signaling.

Alternatively, the one or more candidate (UL) resources may not be derived/determined from the set of resources. When/if (at least) the UE is triggered/requested to transmit the specific message/signaling, it may utilize a legacy UL resource. The legacy UL resource may be a dynamic/configured UL grant. The legacy UL resource may be assigned/provided by the NW based on a scheduling request (from the UE). The UE may not utilize the legacy UL resource to perform Ambient IoT-related transmission (e.g., R2D transmission and/or D2R reception).

Various examples and embodiments of the present invention are described below. For the methods, alternatives, aspects, concepts, examples, and embodiments detailed above and herein, the following aspects and embodiments are possible. Note that any of the above and herein methods, alternatives, aspects, concepts, examples, and embodiments may be combined or applied simultaneously or separately, in whole or in part.

Preferably in certain embodiments, the UE may access, camp on, or (re)select the network node or the carrier/cell. Preferably in certain embodiments, the network node or the carrier/cell supports (A-IoT) intermediate node functionality(ies) for Ambient IoT-related operation).

Preferably in certain embodiments, the UE may (start to) act/operate as an (A-IoT) intermediate node or UE reader (e.g., utilize and/or request the set of resources for Ambient IoT-related operation, e.g., as described in the above concepts), after or in response that the UE receives the (common and/or dedicated) configuration(s) of (A-IoT) intermediate node functionality(ies). Preferably in certain embodiments, the UE may (start to) act/operate as an (A-IoT) intermediate node or UE reader (e.g., utilize and/or request the set of resources for Ambient IoT-related operation, e.g., as described in the above concepts), after or in response that the UE receives an activation/enabling signaling or command from the network node or the carrier/cell.

Preferably in certain embodiments, the UE may stop/terminate acting/operating as an (A-IoT) intermediate node or UE reader after or in response that the UE releases the (common and/or dedicated) configuration(s) of (A-IoT) intermediate node functionality(ies). Preferably in certain embodiments, the UE may stop/terminate acting/operating as an (A-IoT) intermediate node or UE reader after or in response that the UE receives a deactivation/disabling signaling or command from the network node or the carrier/cell.

Preferably in certain embodiments, the UE supporting (A-IoT) intermediate node functionality(ies) may not be an Ambient IoT UE/device. Preferably in certain embodiments, the UE supporting (A-IoT) intermediate node functionality(ies) may not be any of the Device 1, Device 2a, Device 2b.

Throughout the present disclosure, the “UE” may be, be referred to and/or be replaced by an “NR UE”. The “UE” may not be an Ambient IoT UE. The device may be an Ambient IoT UE.

The (Ambient IoT) device(s) may receive a first R2D signaling/message from a reader (e.g., the intermediate UE or the UE reader). The (Ambient IoT) device(s) may perform (or initiate) a first Ambient IoT procedure in response to (or based on) the first R2D signaling/message. The first R2D signaling/message may be a query, a paging (message), a command, a L2 signaling/message (e.g., Medium Access Control (MAC) Control Element (CE), an L1 signaling/message (e.g., Physical Reader (to Ambient IoT) Device Channel (PRDCH), R2D control information) signaling. The first R2D signaling/message may be received by a (Ambient IoT) device, multiple (Ambient IoT) devices or (one or more) group of (Ambient IoT) devices. The first R2D signaling/message may be used to trigger (or indicate) the first Ambient IoT procedure. The first R2D signaling/message may indicate which/what (kind of) (Ambient IoT) device(s) should respond to the first R2D signaling/message. The first R2D signaling/message may indicate which/what (kind of) (Ambient IoT) device(s) is allowed to perform (or initiate) the first Ambient IoT procedure. The first R2D signaling/message may indicate which/what (kind of) data/information is requested to report/provide. The first R2D signaling/message may indicate configuration(s)/resource(s) to be used for the first Ambient IoT procedure.

Preferably in certain embodiments, the first Ambient IoT procedure is different from the first procedure for Uu interface (between the UE and the network node) in the above concepts.

Preferably in certain embodiments, the random access procedure in concepts A-D means the random access procedure for Uu interface. Preferably in certain embodiments, the random access procedure in concepts A˜D means the random access procedure between the UE and the network node.

The first Ambient IoT procedure may be an (initial) Ambient IoT access procedure, an inventory procedure, a command procedure, and/or an “inventory and command” procedure, e.g., for Ambient IoT. The first Ambient IoT procedure may be contention-based or contention free. The (Ambient IoT) device may access the NW/reader, receive R2D signaling/message/configuration, and/or transmit (D2R) data via the first Ambient IoT procedure. The resource(s) and/or configuration(s) for the first Ambient IoT procedure may comprise Physical (Ambient IoT) Device (to) Reader Channel (PDRCH) resource(s), PDRCH occasion(s), frequency and/or band, e.g., for D2R transmission. The resource(s) and/or configuration(s) for the first Ambient IoT procedure may comprise parameter(s), random number, group number and/or assistance information, e.g., for D2R transmission.

One or more of the above embodiment(s), concept(s), aspect(s), method(s), and example(s) could be combined, in whole or in part.

Throughout the present disclosure, PDRCH resources, PDRCH scheduling, D2R grants, D2R resources, and/or D2R scheduling could be interchangeable.

An R2D transmission may be a transmission from a reader to an (Ambient IoT) device. An R2D data may be (available) data on a reader side and/or data to be transmitted from a reader to an (Ambient IoT) device. An R2D transmission and/or R2D data may comprise an indication, configuration, signaling, and/or message from a reader. An R2D reception may be a reception of an R2D transmission.

A D2R transmission may be a transmission from an (Ambient IoT) device to a reader. A D2R data may be (available) data on an (Ambient IoT) device side and/or data to be transmitted from an (Ambient IoT) device to a reader. A D2R transmission and/or D2R data may comprise an indication, signaling, and/or message from an (Ambient IoT) device. A D2R resource and/or PDRCH resource may be or comprise a resource provided from the reader/NW/intermediate node, used by the (Ambient IoT) device and/or used to transmit/perform D2R transmission.

The PDRCH may be or be referred to as a channel for transmission from an (Ambient IoT) device to a reader. The PDRCH may be or be referred to as a (physical) channel for Ambient IoT. The PDRCH may be or be referred to as a (physical) channel for D2R (data/control) transmission. An R2D transmission may be transmission via a PRDCH. The (data and/or signaling) transmission from the reader to the (Ambient IoT) device may be via PRDCH.

The PRDCH may be or be referred to as a channel for transmission from a reader to an (Ambient IoT) device. The PRDCH may be or be referred to as a (physical) channel for Ambient IoT. The PRDCH may be or be referred to as a (physical) channel for R2D (data/control) transmission. A D2R transmission may be transmission via a PDRCH. The (data and/or signaling) transmission from the (Ambient IoT) device to the reader may be via PDRCH.

The (Ambient IoT) device may receive configurations related to Ambient IoT. The (Ambient IoT) device may receive configurations and/or resources for performing/triggering/reporting the first Ambient IoT procedure. The (Ambient IoT) device may receive configurations related to the specific message/signaling, e.g., as described above. The resource(s) and/or configuration(s) may comprise PDRCH (transmission) resource(s), occasion(s), channel resource(s), frequency resource(s), and/or (sub-)band(s), e.g., for D2R transmission. The resource(s) and/or configuration(s) may comprise a parameter, random number, group number, and/or assistance information, e.g., for D2R transmission. The (Ambient IoT) device may monitor/receive the PRDCH in/during the first Ambient IoT procedure.

Throughout the present disclosure, a scheduling may be one or more PDRCH resource(s) for D2R transmission(s) and/or one or more PRDCH resource(s) for R2D reception(s). The scheduling may be (an indication of) a timing and/or frequency.

Throughout the present disclosure, the “reader” may be/mean or replaced by “network”, “network node”, “UE reader”, or “intermediate node”.

Throughout the present disclosure, the TTI/occasion may be a (time) occasion, a symbol, a set of symbols, a slot, a set of slots, and/or a subframe.

The UE may be referred to the UE, an RRC layer of the UE, a MAC entity of the UE or physical layer of the UE.

The device may be referred to the device, an Access Spectrum (AS) layer of the device, a MAC entity of the device or physical layer of the device.

Throughout the present disclosure, the (Ambient IoT) device may be a device used for Ambient IoT. The (Ambient IoT) device may be a device capable of Ambient IoT. The (Ambient IoT) device may be an NR device. The (Ambient IoT) device may be a Long Term Evolution (LTE) device. The (Ambient IoT) device may be an IoT device. The (Ambient IoT) device may be a wearable device. The (Ambient IoT) device may be a sensor. The (Ambient IoT) device may be a stationary device. The (Ambient IoT) device may be a tag.

Throughout the present disclosure, the UE may be a reader used for Ambient IoT, e.g., triggering the first Ambient IoT procedure, transmitting R2D transmission(s), and/or receiving D2R transmission(s). The UE may be a UE capable of (performing) Ambient IoT operation. The UE may be an NR UE. The UE may be an LTE UE. Throughout the present disclosure, the following may be interchangeable: UE, NR UE, normal UE, legacy UE. The UE may be a non-Ambient IoT device.

The network may be/mean a network node. The network (node) may be/mean a base station. The network (node) may be/mean an access point. The network (node) may be/mean an Evolved Node B (eNB). The network (node) may be/mean a gNB. The network (node) may be/mean a gateway. The network may be/mean a reader.

Various examples and embodiments of the present invention are described below. For the methods, alternatives, aspects, concepts, examples, and embodiments detailed above and herein, the following aspects and embodiments are possible.

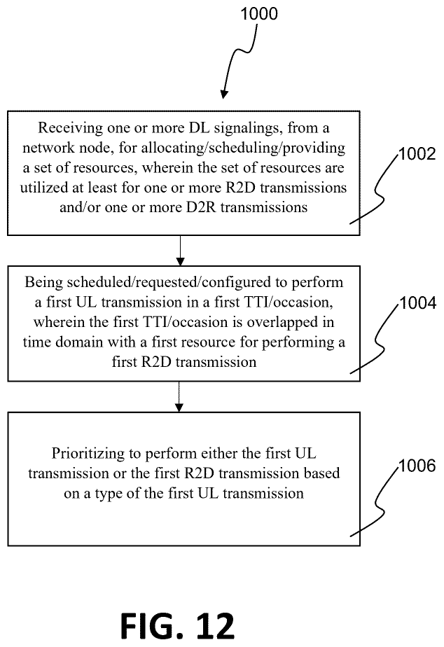

Referring to FIG. 12, with this and other concepts, systems, and methods of the present invention, a method 1000 for a UE in a wireless communication system comprises receiving one or more DL signalings, from a network node, for allocating/scheduling/providing a set of resources, wherein the set of resources are utilized at least for one or more R2D transmissions and/or one or more D2R transmissions (step 1002), being scheduled/requested/configured to perform a first UL transmission in a first TTI/occasion, wherein the first TTI/occasion is overlapped in time domain with a first resource for performing a first R2D transmission (step 1004), and prioritizing to perform either the first UL transmission or the first R2D transmission based on a type of the first UL transmission (step 1006).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signalings, from a network node, for allocating/scheduling/providing a set of resources, wherein the set of resources are utilized at least for one or more R2D transmissions and/or one or more D2R transmissions; (ii) be scheduled/requested/configured to perform a first UL transmission in a first TTI/occasion, wherein the first TTI/occasion is overlapped in time domain with a first resource for performing a first R2D transmission; and (iii) prioritize to perform either the first UL transmission or the first R2D transmission based on a type of the first UL transmission. Moreover, the CPU 308 can execute the program code 312 to perform all of the described actions, steps, and methods described above, below, or otherwise herein.

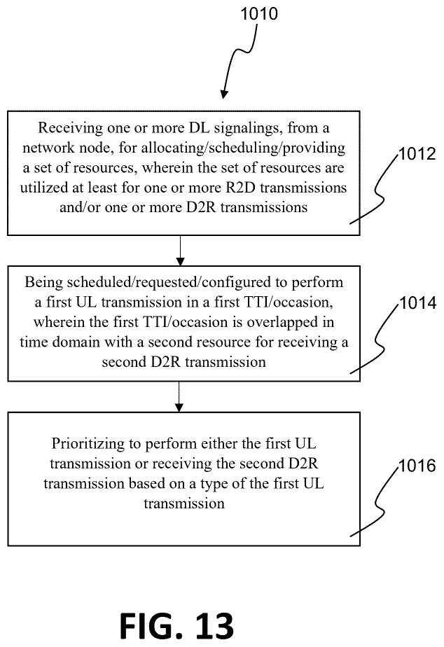

Referring to FIG. 13, with this and other concepts, systems, and methods of the present invention, a method 1010 for a UE in a wireless communication system comprises receiving one or more DL signalings, from a network node, for allocating/scheduling/providing a set of resources, wherein the set of resources are utilized at least for one or more R2D transmissions and/or one or more D2R transmissions (step 1012), being scheduled/requested/configured to perform a first UL transmission in a first TTI/occasion, wherein the first TTI/occasion is overlapped in time domain with a second resource for receiving a second D2R transmission (step 1014), and prioritizing to perform either the first UL transmission or receiving the second D2R transmission based on a type of the first UL transmission (step 1016).

In various embodiments, if the first UL transmission belongs to a first UL type of UL transmission, the UE prioritizes the first UL transmission, if the first UL transmission does not belong to the first UL type of UL transmission, the UE prioritizes the first R2D transmission and/or the second D2R transmission, and/or the first UL type of UL transmission comprises any of PRACH, PUSCH scheduled by a UL grant in a RAR and its retransmission, PUSCH for Type-2 random access procedure and its retransmission, PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signalings, from a network node, for allocating/scheduling/providing a set of resources, wherein the set of resources are utilized at least for one or more R2D transmissions and/or one or more D2R transmissions; (ii) be scheduled/requested/configured to perform a first UL transmission in a first TTI/occasion, wherein the first TTI/occasion is overlapped in time domain with a second resource for receiving a second D2R transmission; and (iii) prioritize to perform either the first UL transmission or receive the second D2R transmission based on a type of the first UL transmission. Moreover, the CPU 308 can execute the program code 312 to perform all of the described actions, steps, and methods described above, below, or otherwise herein.

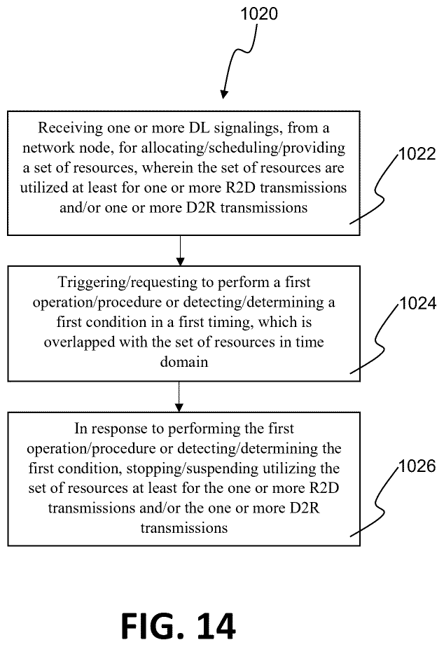

Referring to FIG. 14, with this and other concepts, systems, and methods of the present invention, a method 1020 for a UE in a wireless communication system comprises receiving one or more DL signalings, from a network node, for allocating/scheduling/providing a set of resources, wherein the set of resources are utilized at least for one or more R2D transmissions and/or one or more D2R transmissions (step 1022), triggering/requesting to perform a first operation/procedure or detecting/determining a first condition in a first timing, which is overlapped with the set of resources in time domain (step 1024), and in response to performing the first operation/procedure or detecting/determining the first condition, stopping/suspending utilizing the set of resources at least for the one or more R2D transmissions and/or the one or more D2R transmissions (step 1026).

In various embodiments, the method further comprises: if the first operation/procedure is completed/finished within a first time duration or before a first specific timing, the UE resumes/recovers utilizing the set of resources, and/or if the first condition is solved/recovered within a first time duration or before a first specific timing, the UE resumes/recovers utilizing the set of resources.

In various embodiments, the method further comprises: if the first operation/procedure is not completed/finished at/after an ending time of the first time duration or at/after the first specific timing, the UE releases the set of resources, and/or if the first condition is not solved/recovered at/after the ending time of the first time duration or at/after the first specific timing, the UE releases the set of resources.

In various embodiments, the one or more DL signalings indicate a consecutive/continuous time duration/period(s) of the set of resources, the one or more R2D transmissions and/or the one or more D2R transmissions are performed within the consecutive/continuous time duration/period(s), the first operation/procedure is triggered/requested in the first timing within the consecutive/continuous time duration/period(s), and/or the first condition is detected/determined in the first timing within the consecutive/continuous time duration/period(s).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signalings, from a network node, for allocating/scheduling/providing a set of resources, wherein the set of resources are utilized at least for one or more R2D transmissions and/or one or more D2R transmissions; (ii) trigger/request to perform a first operation/procedure or detect/determine a first condition in a first timing, which is overlapped with the set of resources in time domain; and (iii) in response to performing the first operation/procedure or detect/determine the first condition, stop/suspend utilizing the set of resources at least for the one or more R2D transmissions and/or the one or more D2R transmissions. Moreover, the CPU 308 can execute the program code 312 to perform all of the described actions, steps, and methods described above, below, or otherwise herein.

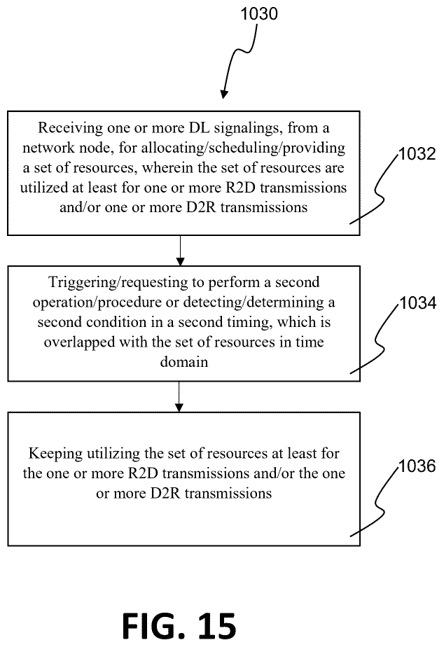

Referring to FIG. 15, with this and other concepts, systems, and methods of the present invention, a method 1030 for a UE in a wireless communication system comprises receiving one or more DL signalings, from a network node, for allocating/scheduling/providing a set of resources, wherein the set of resources are utilized at least for one or more R2D transmissions and/or one or more D2R transmissions (step 1032), triggering/requesting to perform a second operation/procedure or detecting/determining a second condition in a second timing, which is overlapped with the set of resources in time domain (step 1034), and keeping utilizing the set of resources at least for the one or more R2D transmissions and/or the one or more D2R transmissions (step 1036).

In various embodiments, the method further comprises: if the second operation/procedure is not completed/finished at/after ending time of a second time duration or at/after a second specific timing, the UE releases the set of resources, and/or if the second condition is not solved/recovered at/after ending time of the second time duration or at/after the second specific timing, the UE releases the set of resources.

In various embodiments, the one or more DL signalings indicate a consecutive/continuous time duration/period(s) of the set of resources, the one or more R2D transmissions and/or the one or more D2R transmissions are performed within the consecutive/continuous time duration/period(s), the second operation/procedure is triggered/requested in the second timing within the consecutive/continuous time duration/period(s), and/or the second condition is detected/determined in the second timing within the consecutive/continuous time duration/period(s).

In various embodiments, the first operation/procedure/condition is different from the second operation/procedure/condition.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signalings, from a network node, for allocating/scheduling/providing a set of resources, wherein the set of resources are utilized at least for one or more R2D transmissions and/or one or more D2R transmissions; (ii) trigger/request to perform a second operation/procedure or detect/determine a second condition in a second timing, which is overlapped with the set of resources in time domain; and (iii) keep utilizing the set of resources at least for the one or more R2D transmissions and/or the one or more D2R transmissions. Moreover, the CPU 308 can execute the program code 312 to perform all of the described actions, steps, and methods described above, below, or otherwise herein.

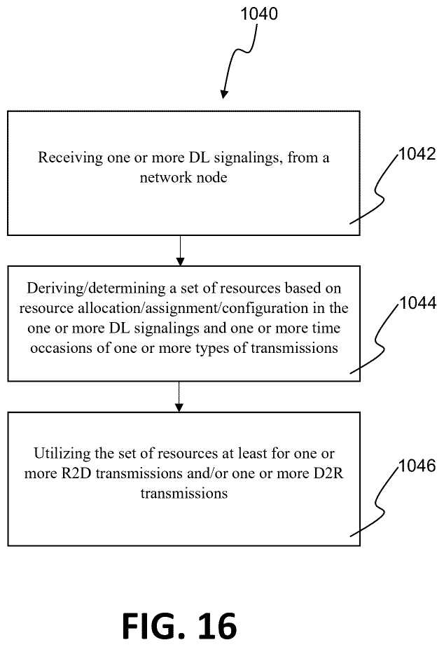

Referring to FIG. 16, with this and other concepts, systems, and methods of the present invention, a method 1040 for a UE in a wireless communication system comprises receiving one or more DL signalings, from a network node (step 1042), deriving/determining a set of resources based on resource allocation/assignment/configuration in the one or more DL signalings and one or more time occasions of one or more types of transmissions (step 1044), and utilizing the set of resources at least for one or more R2D transmissions and/or one or more D2R transmissions (step 1046).

In various embodiments, the method further comprises: the one or more DL signalings indicate a starting timing and/or a (consecutive/continuous) time duration/period, and/or for determining/deriving the set of resources, the UE excludes one or more time occasions of the one or more types of transmissions from the (consecutive/continuous) time duration/period.

In various embodiments, the one or more types of transmissions comprise any of PRACH, PUSCH scheduled by a UL grant in a RAR and its retransmission, PUSCH for Type-2 random access procedure and its retransmission, PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signalings, from a network node; (ii) derive/determine a set of resources based on resource allocation/assignment/configuration in the one or more DL signalings and one or more time occasions of one or more types of transmissions; and (iii) utilize the set of resources at least for one or more R2D transmissions and/or one or more D2R transmissions. Moreover, the CPU 308 can execute the program code 312 to perform all of the described actions, steps, and methods described above, below, or otherwise herein.

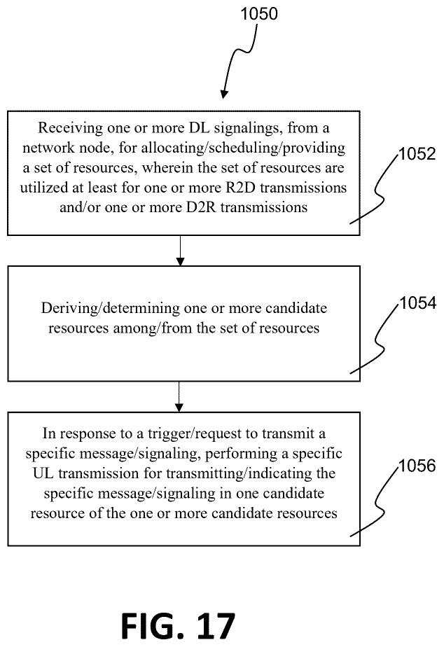

Referring to FIG. 17, with this and other concepts, systems, and methods of the present invention, a method 1050 for a UE in a wireless communication system comprises receiving one or more DL signalings, from a network node, for allocating/scheduling/providing a set of resources, wherein the set of resources are utilized at least for one or more R2D transmissions and/or one or more D2R transmissions (step 1052), deriving/determining one or more candidate resources among/from the set of resources (step 1054), and in response to a trigger/request to transmit a specific message/signaling, performing a specific UL transmission for transmitting/indicating the specific message/signaling in one candidate resource of the one or more candidate resources (step 1056).

In various embodiments, if the UE is not triggered/requested to transmit the specific message/signaling, the one or more candidate (UL) resources are (considered to be) utilized for the one or more R2D transmissions and/or the one or more D2R transmissions.

In various embodiments, the one or more candidate resources are periodic resources in time domain, and/or the one or more candidate (UL) resources are located in a last one or more TTIs/occasions of a (consecutive/continuous) time duration/period for the set of resources.

In various embodiments, the specific message/signaling is/comprises a report/indication/feedback of Ambient IoT-related operations/procedures, the specific message/signaling is/comprises report/indication/feedback of utilization of the set of resources, the specific message/signaling is/comprises report/indication/feedback of finishing/completeness of the Ambient IoT-related operations/procedures, and/or the specific message/signaling is/comprises an inventory/query report (of Ambient IoT devices).

In various embodiments, the UE is an Ambient IoT reader or an (A-IoT) intermediate node.

In various embodiments, the set of resources are utilized at least for performing Ambient IoT-related operations/procedures, and/or the one or more R2D transmissions and/or the one or more D2R transmissions are performed for Ambient IoT-related operations/procedures.

In various embodiments, the UE (starts to) acts/operates as an (A-IoT) intermediate node, after or in response that the UE receives a (common and/or dedicated) configuration(s) of (A-IoT) intermediate node functionality(ies) from the network node, and/or the UE (starts to) acts/operates as an (A-IoT) intermediate node, after or in response that the UE receives an activation/enabling signaling or command, for Ambient IoT-related operations/procedures, from the network node.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more DL signalings, from a network node, for allocating/scheduling/providing a set of resources, wherein the set of resources are utilized at least for one or more R2D transmissions and/or one or more D2R transmissions; (ii) derive/determine one or more candidate resources among/from the set of resources; and (iii) in response to a trigger/request to transmit a specific message/signaling, perform a specific UL transmission for transmitting/indicating the specific message/signaling in one candidate resource of the one or more candidate resources. Moreover, the CPU 308 can execute the program code 312 to perform all of the described actions, steps, and methods described above, below, or otherwise herein.

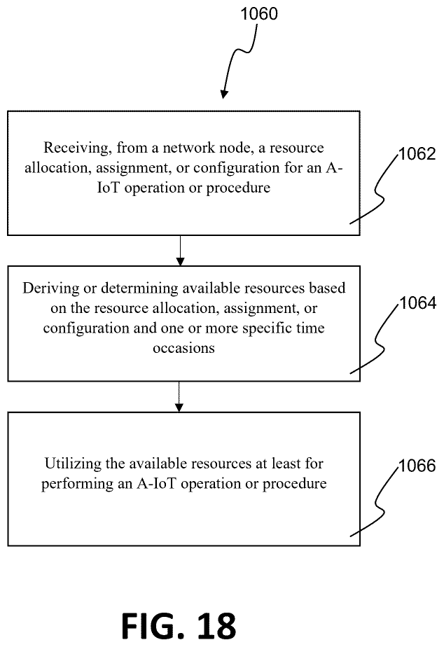

Referring to FIG. 18, with this and other concepts, systems, and methods of the present invention, a method 1060 for a UE in a wireless communication system comprises receiving, from a network node, a resource allocation, assignment, or configuration for an A-IoT operation or procedure (step 1062), deriving or determining available resources based on the resource allocation, assignment, or configuration and one or more specific time occasions (step 1064), and utilizing the available resources at least for performing the A-IoT operation or procedure (step 1066).

In various embodiments, for determining or deriving the available resources, the UE excludes the one or more specific time occasions from a plurality of time occasions associated with the resource allocation, assignment, or configuration, the UE excludes the one or more specific time occasions from the plurality of time occasions indicated by the resource allocation, assignment, or configuration, the UE excludes any frequency resources in the one or more specific time occasions from a plurality of resources associated with the resource allocation, assignment, or configuration, and/or the UE excludes any frequency resources in the one or more specific time occasions from the plurality of resources indicated by the resource allocation, assignment, or configuration.

In various embodiments, the UE receives one or more downlink signalings for indicating the resource allocation, assignment, or configuration. The one or more downlink signalings or the resource allocation, assignment, or configuration indicate at least one frequency resource for indicating the resource allocation or configuration, the one or more downlink signalings indicate a (consecutive or continuous) time duration, a time period, and/or a starting timing for indicating the resource allocation or configuration, and/or the resource allocation, assignment, or configuration comprises the (consecutive or continuous) time duration, the time period, and/or the starting timing.

In various embodiments, for determining or deriving the available resources, the UE excludes the one or more specific time occasions from the (consecutive or continuous) time duration and/or the time period, and/or for determining or deriving the available resources, the UE excludes any frequency resources in the one or more specific time occasions from the (consecutive or continuous) time duration and/or the time period.

In various embodiments, the one or more specific time occasions comprise first time occasions of one or more types of downlink transmissions, the first time occasions are configured, indicated or scheduled by the network node, and/or the one or more types of downlink transmissions comprise any of (transmission of) PDCCH, PDCCH in a CORESET with index 0, PDCCH in a Type0-PDCCH CSS set, PDCCH in a Type1-PDCCH CSS set, PDCCH in a Type1A-PDCCH CSS set, PDCCH in a Type2-PDCCH CSS set, PDCCH in a Type2A-PDCCH CSS set, PDCCH in a Type3-PDCCH CSS set, PDCCH in a CSS set, PDSCH scheduled by a DCI format with CRC scrambled by RA-RNTI, PDSCH scheduled by a DCI format with CRC scrambled by MsgB-RNTI, PDSCH scheduled by a DCI format with CRC scrambled by TC-RNTI, PDSCH scheduled by a DCI format with CRC scrambled by P-RNTI, PDSCH scheduled by a DCI format with CRC scrambled by SI-RNTI, PDSCH scheduled by a DCI format with CRC scrambled by SFI-RNTI, PDSCH scheduled by a DCI format with CRC scrambled by CS-RNTI, SS/PBCH block, or aperiodic CSI-RS.

In various embodiments, the one or more specific time occasions comprise time duration for performing a random access procedure (with the network node). In various embodiments, the one or more specific time occasions comprises PRACH and/or PUSCH scheduled by a UL grant in a RAR in the random access procedure.

In various embodiments, the one or more specific time occasions are for uplink transmissions, the one or more specific time occasions comprise second time occasions of one or more types of uplink transmissions, the second time occasions are configured, indicated or scheduled by the network node, and/or the one or more types of uplink transmissions comprise any of (transmission of) PRACH, PUSCH scheduled by a UL grant in a RAR and corresponding RAR retransmission, PUSCH for Type-2 random access procedure and corresponding PUSCH retransmission, PUSCH scheduled by DCI, PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS, and/or the one or more types of uplink transmissions comprise any of configured uplink grant for PUSCH, configured uplink grant type 1 for PUSCH, configured uplink grant type 2 for PUSCH, periodic CSI report, or periodic SRS.

In various embodiments, a time occasion is or comprises any of a symbol, a set of symbols, a slot, a set of slots, a subframe, and/or a set of subframes, the (consecutive or continuous) time duration is with a time unit of a symbol, a slot, a subframe, or millisecond, and/or the time period is with a time unit of a symbol, a slot, a subframe, or a millisecond.

In various embodiments, utilizing the available resources comprises indicating/transmitting the available resources to lower layer(s) (e.g., MAC entity, physical layer), transmitting an R2D message using the available resources, and/or including the available resources in an R2D message.

In various embodiments, performing the A-IoT operation or procedure comprises performing one or more R2D transmissions, scheduling one or more D2R transmissions, and/or reception of the one or more D2R transmissions (from one or more A-IoT devices), the one or more R2D transmissions and/or (the reception of) the one or more D2R transmissions are performed within the available resources, the UE prevents or excludes from performing the A-IoT operation or procedure outside the available resources, the UE prevents or excludes from performing an R2D transmission, which overlaps with the one or more specific time occasions, the UE prevents or excludes from scheduling a D2R transmission, which overlaps with the one or more specific time occasions, the UE prevents or excludes from allocating or assigning resources (to one or more A-IoT devices) for the A-IoT operation or procedure outside the available resources, the UE prevents or excludes from allocating or assigning resources (to one or more A-IoT devices) for the A-IoT operation or procedure in the one or more specific time occasions, the UE is an A-IoT reader or an (A-IoT) intermediate node, and/or the UE receives, from the network node, a configuration, an indication, and/or a request related to the A-IoT operation or procedure.

In various embodiments, preventing/excluding from performing the A-IoT operation/procedure comprises skipping and/or not performing an R2D and/or D2R transmission, and/or preventing/excluding from allocating/assigning resources for the A-IoT operation/procedure comprises not including a scheduling information (of the resources) for the D2R transmission in an R2D message.

In various embodiments, the UE may derive/determine the (available/usable) set of resources in response to receiving the resource allocation, assignment, or configuration, obtaining information of the one or more specific time occasions, and/or before performing the Ambient IoT-related operation or procedure.

Referring back to FIGS. 3 and 4, in one or more embodiments from the perspective of a UE (or A-IoT device) in a wireless communication system, the device 300 includes a program code 312 stored in memory 310 of the transmitter. The CPU 308 could execute program code 312 to: (i) receive, from a network node, a resource allocation, assignment, or configuration for an A-IoT operation or procedure; (ii) derive or determine available resources based on the resource allocation, assignment, or configuration and one or more specific time occasions; and (iii) utilize the available resources at least for performing the A-IoT operation or procedure. Moreover, the CPU 308 can execute the program code 312 to perform all of the described actions, steps, and methods described above, below, or otherwise herein.

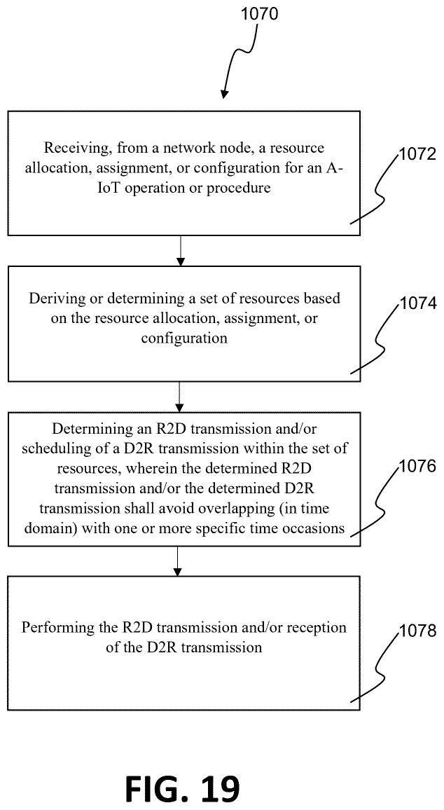

Referring to FIG. 19, with this and other concepts, systems, and methods of the present invention, a method 1070 for a UE in a wireless communication system comprises receiving, from a network node, a resource allocation, assignment, or configuration for an A-IoT operation or procedure (step 1072), deriving or determining a set of resources based on the resource allocation, assignment, or configuration (step 1074), determining an R2D transmission and/or scheduling of a D2R transmission within the set of resources, wherein the determined R2D transmission and/or the scheduled/determined D2R transmission shall avoid overlapping (in time domain) with one or more specific time occasions (step 1076), and performing the R2D transmission and/or reception of the D2R transmission (step 1078).

In various embodiments, the UE prevents/excludes from determining the R2D transmission and/or the D2R transmission such that overlapping (in time domain) with the one or more specific time occasions.

In various embodiments, the UE excludes the one or more specific time occasions when the UE determines available resources for the R2D transmission and/or the D2R transmission.

In various embodiments, when determining the R2D transmission and/or the scheduling of the D2R transmission, the UE is required to avoid overlapping (in time domain) between the one or more specific time occasions and the determined R2D transmission and/or the scheduled/determined D2R transmission.

In various embodiments, the UE determines the R2D transmission and/or the scheduling of the D2R transmission by excluding the one or more specific time occasions, if any.

In various embodiments, the UE may derive/determine/check the one or more specific time occasions before determining the R2D transmission and/or scheduling of the D2R transmission.

In various embodiments, the R2D transmission and/or (the reception of) the D2R transmission are performed within the set of resources, the UE prevents or excludes from performing any R2D transmission, which overlaps with the one or more specific time occasions, the UE prevents or excludes from scheduling any D2R transmission, which overlaps with the one or more specific time occasions, the UE prevents or excludes from allocating or assigning resources for the A-IoT operation or procedure outside the set of resources, the UE prevents or excludes from allocating or assigning resources for the A-IoT operation or procedure in the one or more specific time occasions, the UE is an A-IoT reader or an (A-IoT) intermediate node, and/or the UE receives, from the network node, a configuration, an indication, and/or a request related to the A-IoT operation or procedure.

In various embodiments, preventing/excluding from performing the R2D transmission comprises skipping and/or not performing the R2D transmission, and/or preventing/excluding from scheduling the D2R transmission comprises not including a scheduling information for the D2R transmission in an R2D message.

In various embodiments, the UE receives one or more downlink signalings for indicating the resource allocation, assignment, or configuration. The one or more downlink signalings or the resource allocation, assignment, or configuration indicate at least one frequency resource for indicating the resource allocation or configuration, the one or more downlink signalings indicate a (consecutive or continuous) time duration, a time period, and/or a starting timing for indicating the resource allocation or configuration, and/or the resource allocation, assignment, or configuration comprises the (consecutive or continuous) time duration, the time period, and/or the starting timing.

In various embodiments, the one or more specific time occasions comprise first time occasions of one or more types of downlink transmissions, the first time occasions are configured, indicated, or scheduled by the network node, and/or the one or more types of downlink transmissions comprise any of (transmission of) PDCCH, PDCCH in a CORESET with index 0, PDCCH in a Type0-PDCCH CSS set, PDCCH in a Type1-PDCCH CSS set, PDCCH in a Type1A-PDCCH CSS set, PDCCH in a Type2-PDCCH CSS set, PDCCH in a Type2A-PDCCH CSS set, PDCCH in a Type3-PDCCH CSS set, PDCCH in a CSS set, PDSCH scheduled by a DCI format with CRC scrambled by RA-RNTI, PDSCH scheduled by a DCI format with CRC scrambled by MsgB-RNTI, PDSCH scheduled by a DCI format with CRC scrambled by TC-RNTI, PDSCH scheduled by a DCI format with CRC scrambled by P-RNTI, PDSCH scheduled by a DCI format with CRC scrambled by SI-RNTI, PDSCH scheduled by a DCI format with CRC scrambled by SFI-RNTI, PDSCH scheduled by a DCI format with CRC scrambled by CS-RNTI, SS/PBCH block, or aperiodic CSI-RS.

In various embodiments, the one or more specific time occasions comprise time duration for performing random access procedure (with the network node). In various embodiments, the one or more specific time occasions comprises PRACH and/or PUSCH scheduled by a UL grant in an RAR in the random access procedure.

In various embodiments, the one or more specific time occasions are for uplink transmissions, the one or more specific time occasions comprise second time occasions of one or more types of uplink transmissions, the second time occasions are configured, indicated, or scheduled by the network node, and/or the one or more types of uplink transmissions comprise any of (transmission of) PRACH, PUSCH scheduled by a UL grant in a RAR and corresponding RAR retransmission, PUSCH for Type-2 random access procedure and corresponding PUSCH retransmission, PUSCH scheduled by DCI, PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS, and/or the one or more types of uplink transmissions comprise any of configured uplink grant for PUSCH, configured uplink grant type 1 for PUSCH, configured uplink grant type 2 for PUSCH, periodic CSI report, or periodic SRS.

In various embodiments, a time occasion is or comprises any of a symbol, a set of symbols, a slot, a set of slots, a subframe, and/or a set of subframes, the (consecutive) time duration is with a time unit of a symbol, a slot, a subframe, or millisecond, and/or the time period is with a time unit of a symbol, a slot, a subframe, or a millisecond.

Referring back to FIGS. 3 and 4, in one or more embodiments from the perspective of a UE (or A-IoT device) in a wireless communication system, the device 300 includes a program code 312 stored in memory 310 of the transmitter. The CPU 308 could execute program code 312 to: (i) receive, from a network node, a resource allocation, assignment, or configuration for an A-IoT operation or procedure; (ii) derive or determine a set of resources based on the resource allocation, assignment, or configuration; (iii) determine an R2D transmission and/or schedule a D2R transmission within the set of resources, wherein the determined R2D transmission and/or the scheduled/determined D2R transmission shall avoid overlapping with one or more specific time occasions, and (iv) perform the R2D transmission and/or receive the D2R transmission. Moreover, the CPU 308 can execute the program code 312 to perform all of the described actions, steps, and methods described above, below, or otherwise herein.

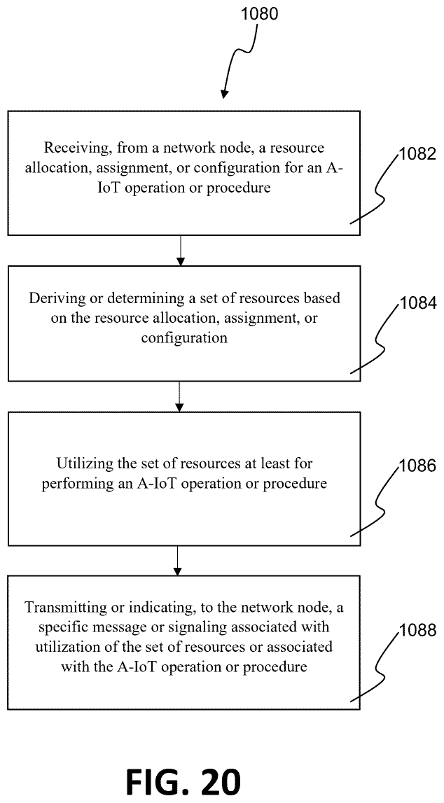

Referring to FIG. 20, with this and other concepts, systems, and methods of the present invention, a method 1080 for a UE in a wireless communication system comprises receiving, from a network node, a resource allocation, assignment, or configuration for an A-IoT operation or procedure (step 1082), deriving or determining a set of resources based on the resource allocation, assignment, or configuration (step 1084), utilizing the set of resources at least for performing the A-IoT operation or procedure (step 1086), and transmitting or indicating, to the network node, a specific message or signaling associated with utilization of the set of resources or associated with the A-IoT operation or procedure (step 1088).

In various embodiments, the method further comprises deriving or determining one or more resources among or from the set of resources or another set of resources, wherein the another set of resources are configured for transmitting the specific message or signaling, and/or transmitting or indicating the specific message or the signaling on the one or more resources.

In various embodiments, the UE transmits or indicates the specific message or the signaling in response to finishing, completeness, or termination of the A-IoT operation or procedure, the specific message or the signaling is or comprises a report or a feedback of the A-IoT operation or procedure, the specific message or the signaling is or comprises a report or an indication or a feedback of the finishing, completeness, or termination of the A-IoT operation or procedure, and/or the specific message or the signaling is or comprises a (indication of) release or a deactivation request of the set of resources and/or the resource allocation, assignment, or configuration.

In various embodiments, utilizing the available resources comprises indicating/transmitting the available resources to lower layer(s) (e.g., MAC entity, physical layer), transmitting an R2D message using the available resources, and/or including the available resources in an R2D message.

In various embodiments, performing the A-IoT operation or procedure comprises performing one or more R2D transmissions and/or one or more D2R receptions (with one or more A-IoT devices), the UE prevents or excludes from performing the A-IoT operation or procedure outside the set of resources, the UE prevents or excludes from allocating or assigning resources (to one or more A-IoT devices) for the A-IoT operation or procedure outside the set of resources, the UE is an A-IoT reader or an (A-IoT) intermediate node, and/or the UE receives, from the network node, a configuration, an indication, and/or a request related to the A-IoT operation or procedure.

In various embodiments, preventing/excluding from performing the A-IoT operation/procedure comprises skipping and/or not performing an R2D and/or D2R transmission, and/or preventing/excluding from allocating/assigning resources for the A-IoT operation/procedure comprises not including a scheduling information (of the resources) for the D2R transmission in an R2D message.

In various embodiments, the method further comprises triggering or requesting to perform an operation or procedure or detecting or determining a condition in a timing, which is overlapped with the set of resources in time domain, or triggering or requesting to perform the operation or procedure or detecting or determining the condition when the A-IoT operation or procedure is ongoing, wherein the operation or procedure or the condition comprises any of a random access procedure, an LTM procedure, a beam failure recovery, a Link recovery, a handover, a TA timer expires, a physical layer problem detection, or a radio link failure, and keeping utilizing the set of resources for performing the A-IoT operation or procedure at least when the operation or procedure is performed or before the condition is solved.

In various embodiments, the method further comprises triggering or requesting to perform an operation or procedure or detecting or determining a condition in a timing, which is overlapped with the set of resources in time domain, or triggering or requesting to perform the operation or procedure or detecting or determining the condition when the A-IoT operation or procedure is ongoing, wherein the operation or procedure or the condition comprises any of a random access procedure, an LTM procedure, a beam failure recovery, a Link recovery, a handover, a TA timer expiration, a physical layer problem detection, or a radio link failure, and stopping or suspending (utilizing the set of resources for) performing the A-IoT operation or procedure at least when the operation or procedure is performed or before the condition is solved.

In various embodiments, the method further comprises being scheduled, requested, or configured to perform a UL transmission, an SL transmission, or a DL reception (in a first TTI or occasion), when the UL transmission, the SL transmission, or the DL reception (or the first TTI or occasion) is overlapped in time domain with a first resource, within the set of resources, for performing a first R2D transmission, prioritizing to perform either the UL transmission, the SL transmission, or the DL reception or the first R2D transmission based on a type of the UL transmission, the SL transmission, or the DL reception, and/or when the UL transmission, the SL transmission, or the DL reception (or the first TTI or occasion) is overlapped in time domain with a second resource, within the set of resources, for receiving a second D2R transmission, prioritizing to perform either the UL transmission, the SL transmission, or the DL reception or receiving the second D2R transmission based on the type of the UL transmission, the SL transmission, or the DL reception.

In various embodiments, the method further comprises being scheduled, requested, or configured to perform a UL transmission, an SL transmission, or a DL reception (in a first TTI or occasion), when/if the UL transmission, the SL transmission, or the DL reception (or the first TTI or occasion) is overlapped in time domain with the set of resources, the UE is required to prioritize the UL transmission, the SL transmission, or the DL reception (over any R2D/D2R/A-IoT transmission/reception/operation), and/or when/if the UL transmission, the SL transmission, or the DL reception is overlapped in time domain with the set of resources, the UE is required to perform the UL transmission, the SL transmission, or DL reception, and/or the UE is required to skip, drop, or suspend any R2D transmission or any D2R reception, if any, during the UL transmission, the SL transmission, or the DL reception. In various embodiments, A-IoT transmission and reception is always de-prioritized than the UL transmission, the SL transmission, or the DL reception.

In various embodiments, if the first UL transmission belongs to a first UL type of UL transmission, the UE prioritizes the first UL transmission, if the first UL transmission does not belong to the first UL type of UL transmission, the UE prioritizes the first R2D transmission and/or the second D2R transmission, and/or the first UL type of UL transmission comprises any of (transmission of) PRACH, PUSCH scheduled by a UL grant in a RAR and corresponding RAR retransmission, PUSCH for Type-2 random access procedure and corresponding PUSCH retransmission, PUCCH with HARQ-ACK information in response to successRAR, PUCCH indicated by a DCI format 1_0 with CRC scrambled by a corresponding TC-RNTI, PUCCH with (positive and/or negative) SR, PUCCH with HARQ-ACK information, PUCCH with SL HARQ-ACK information, PUCCH with CSI report, PUSCH with aperiodic CSI report, or aperiodic SRS.

Referring back to FIGS. 3 and 4, in one or more embodiments from the perspective of a UE (or A-IoT device) in a wireless communication system, the device 300 includes a program code 312 stored in memory 310 of the transmitter. The CPU 308 could execute program code 312 to: (i) receive, from a network node, a resource allocation, assignment, or configuration for an A-IoT operation or procedure; (ii) derive or determine a set of resources based on the resource allocation, assignment, or configuration; (iii) utilize the set of resources at least for performing the A-IoT operation or procedure; and (iv) transmit or indicate, to the network node, a specific message or signaling associated with utilization of the set of resources or associated with the A-IoT operation or procedure. Moreover, the CPU 308 can execute the program code 312 to perform all of the described actions, steps, and methods described above, below, or otherwise herein.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) transmit, to a UE, a resource allocation, assignment, or configuration for an A-IoT operation or procedure; (ii) expect or assume that the UE performs an A-IoT operation or procedure within a set of resources derived/determined based on the resource allocation, assignment, or configuration; and (iii) receive, from the UE, a specific message or signaling associated with utilization of the set of resources or associated with the A-IoT operation or procedure. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving, from a network node, a resource allocation or configuration for an Ambient Internet of Things (A-IoT) operation or procedure;
deriving or determining available resources based on the resource allocation or configuration and one or more specific time occasions; and
utilizing the available resources at least for performing the A-IoT operation or procedure.

2. The method of claim 1, wherein at least one of:
for determining or deriving the available resources, the UE excludes the one or more specific time occasions from a plurality of time occasions associated with the resource allocation or configuration,
for determining or deriving the available resources, the UE excludes the one or more specific time occasions from the plurality of time occasions indicated by the resource allocation or configuration,
for determining or deriving the available resources, the UE excludes any frequency resources in the one or more specific time occasions from a plurality of resources associated with the resource allocation or configuration, and/or
for determining or deriving the available resources, the UE excludes any frequency resources in the one or more specific time occasions from the plurality of resources indicated by the resource allocation or configuration.

3. The method of claim 1, wherein at least one of:
the resource allocation or configuration is indicated by one or more downlink signalings,
the one or more downlink signalings or the resource allocation or configuration indicate at least one frequency resource,
the one or more downlink signalings indicate a time duration, a time period, and/or a starting timing for indicating the resource allocation or configuration, and/or
the resource allocation or configuration comprises the time duration, the time period, and/or the starting timing,
for determining or deriving the available resources, the UE excludes the one or more specific time occasions from the time duration and/or the time period, and/or
for determining or deriving the available resources, the UE excludes any frequency resources in the one or more specific time occasions from the time duration and/or the time period, and/or
a time occasion is or comprises any of a symbol, a set of symbols, a slot, a set of slots, a subframe, and/or a set of subframes,
the time duration is with a time unit of a symbol, a slot, a subframe, or millisecond, and/or
the time period is with a time unit of a symbol, a slot, a subframe, or a millisecond.

4. The method of claim 1, wherein at least one of:
the one or more specific time occasions comprises time duration for performing a random access procedure with the network node, and/or
the one or more specific time occasions comprises Physical Random Access Channel (PRACH) and/or Physical Uplink Shared Channel (PUSCH) scheduled by an Uplink (UL) grant in a Random Access Response (RAR) in the random access procedure.

5. The method of claim 1, wherein at least one of:
the one or more specific time occasions are for UL transmissions,
the one or more specific time occasions comprise time occasions of one or more types of uplink transmissions,
the one or more specific time occasions are configured, indicated, or scheduled by the network node,
the one or more types of uplink transmissions comprise any of PRACH, PUSCH scheduled by a UL grant in a RAR and/or corresponding RAR retransmission, PUSCH for Type-2 random access procedure and corresponding PUSCH retransmission, PUSCH scheduled by downlink control information (DCI), Physical Uplink Control Channel (PUCCH) with Hybrid Automatic Repeat Request (HARQ)-Acknowledgement (ACK) information in response to successRAR, PUCCH indicated by a DCI format 1_0 with CRC scrambled by a corresponding TC-RNTI, PUCCH with Scheduling Request (SR), PUCCH with HARQ-ACK information, PUCCH with Sidelink (SL) HARQ-ACK information, PUCCH with CSI report, PUSCH with aperiodic CSI report, or aperiodic Sounding Reference Signal (SRS), and/or
the one or more types of uplink transmissions comprise any of configured uplink grant for PUSCH, configured uplink grant type 1 for PUSCH, configured uplink grant type 2 for PUSCH, periodic CSI report, or periodic SRS.

6. The method of claim 1, wherein at least one of:
the A-IoT operation or procedure comprises performing one or more Reader-to-Device (R2D) transmissions, scheduling one or more Device-to-Reader (D2R) transmissions, and/or reception of the one or more D2R transmissions,
the one or more R2D transmissions and/or the reception of the one or more D2R transmissions are performed within the available resources,
the UE prevents or excludes from performing the A-IoT operation or procedure outside the available resources,
the UE prevents or excludes from performing an R2D transmission, which overlaps with the one or more specific time occasions,
the UE prevents or excludes from scheduling a D2R transmission, which overlaps with the one or more specific time occasions,
the UE prevents or excludes from allocating or assigning resources for the A-IoT operation or procedure outside the available resources,
the UE prevents or excludes from allocating or assigning resources for the A-IoT operation or procedure in the one or more specific time occasions,
the UE is an A-IoT reader or an A-IoT intermediate node, and/or
the UE receives, from the network node, a configuration, an indication, and/or a request related to the A-IoT operation or procedure.

7. A method for a User Equipment (UE), comprising:
receiving, from a network node, a resource allocation or configuration for an Ambient Internet of Things (A-IoT) operation or procedure;
deriving or determining a set of resources based on the resource allocation or configuration;
determining a Reader-to-Device (R2D) transmission and/or scheduling of a Device-to-Reader (D2R) transmission within the set of resources, wherein the determined R2D transmission and/or the scheduled D2R transmission shall avoid overlapping with one or more specific time occasions; and
performing the R2D transmission and/or reception of the D2R transmission.

8. The method of claim 7, wherein at least one of:
the R2D transmission and/or the reception of the D2R transmission are performed within f 30 resources,
the UE prevents or excludes from performing any R2D transmission, which overlaps with the one or more specific time occasions,
the UE prevents or excludes from scheduling any D2R transmission, which overlaps with the one or more specific time occasions,
the UE prevents or excludes from allocating or assigning resources for the A-IoT operation or procedure outside the set of resources,
the UE prevents or excludes from allocating or assigning resources for the A-IoT operation or procedure in the one or more specific time occasions,
the UE is an A-IoT reader or an A-IoT intermediate node, and/or
the UE receives, from the network node, a configuration, an indication, and/or a request related to the A-IoT operation or procedure.

9. The method of claim 7, wherein at least one of:
the resource allocation or configuration is indicated by one or more downlink signalings,
the one or more downlink signalings or the resource allocation or configuration indicate at least one frequency resource,
the one or more downlink signalings indicate a time duration, a time period, and/or a starting timing for indicating the resource allocation or configuration,
the resource allocation or configuration comprises the time duration, the time period, and/or the starting timing,
a time occasion is or comprises any of a symbol, a set of symbols, a slot, a set of slots, a subframe, and/or a set of subframes,
the time duration is with a time unit of a symbol, a slot, a subframe, or a millisecond, and/or
the time period is with a time unit of a symbol, a slot, a subframe, or a millisecond.

10. The method of claim 7, wherein at least one of:
the one or more specific time occasions comprises time duration for performing a random access procedure with the network node, and/or
the one or more specific time occasions comprises Physical Random Access Channel (PRACH) and/or Physical Uplink Shared Channel (PUSCH) scheduled by an Uplink (UL) grant in a Random Access Response (RAR) in the random access procedure.

11. The method of claim 7, wherein at least one of:
the one or more specific time occasions are for UL transmissions,
the one or more specific time occasions comprise time occasions of one or more types of uplink transmissions,
the one or more specific time occasions are configured, indicated or scheduled by the network node,
the one or more types of uplink transmissions comprise any of PRACH, PUSCH scheduled by a UL grant in a RAR and corresponding RAR retransmission, PUSCH for Type-2 random access procedure and corresponding PUSCH retransmission, PUSCH scheduled by downlink control information (DCI), Physical Uplink Control Channel (PUCCH) with Hybrid Automatic Repeat Request (HARQ)-Acknowledgement (ACK) information in response to successRAR, PUCCH indicated by a DCI format 1_0 with CRC scrambled by a corresponding TC-RNTI, PUCCH with Scheduling Request (SR), PUCCH with HARQ-ACK information, PUCCH with Sidelink (SL) HARQ-ACK information, PUCCH with CSI report, PUSCH with aperiodic CSI report, or aperiodic Sounding Reference Signal (SRS), and/or
the one or more types of uplink transmissions comprise any of configured uplink grant for PUSCH, configured uplink grant type 1 for PUSCH, configured uplink grant type 2 for PUSCH, periodic CSI report, or periodic SRS.

12. A method for a User Equipment (UE), comprising:
receiving, from a network node, a resource allocation or configuration for an Ambient Internet of Things (A-IoT) operation or procedure;
deriving or determining a set of resources based on the resource allocation or configuration;
utilizing the set of resources at least for performing the A-IoT operation or procedure; and
transmitting or indicating, to the network node, a specific message or signaling associated with utilization of the set of resources or associated with the A-IoT operation or procedure.

13. The method of claim 12, further comprising:
deriving or determining one or more resources among or from the set of resources or another set of resources, wherein the another set of resources are configured for transmitting the specific message or signaling; and/or
transmitting or indicating the specific message or the signaling on the one or more resources.

14. The method of claim 12, wherein:
the UE transmits or indicates the specific message or the signaling in response to finishing, completeness, or termination of the A-IoT operation or procedure,
the specific message or the signaling is or comprises a report or a feedback of the A-IoT operation or procedure,
the specific message or the signaling is or comprises a report or an indication or a feedback of the finishing, completeness, or termination of the A-IoT operation or procedure, and/or
the specific message or the signaling is or comprises a release or a deactivation request of the set of resources and/or the resource allocation, assignment, or configuration.

15. The method of claim 12, wherein:
performing the A-IoT operation or procedure comprises performing one or more Reader-to-Device (R2D) transmissions and/or one or more Device-to-Reader (D2R) receptions,
the UE prevents or excludes from performing the A-IoT operation or procedure outside f 10 resources,
the UE prevents or excludes from allocating or assigning resources for the A-IoT operation or procedure outside the set of resources,
the UE is an A-IoT reader or an A-IoT intermediate node, and/or
the UE receives, from the network node, a configuration, an indication, and/or a request related to the A-IoT operation or procedure.

16. The method of claim 12, further comprising:
being scheduled, requested, or configured to perform a first Uplink (UL) transmission, a first Sidelink (SL) transmission, or a first Downlink (DL) reception;
when the first UL transmission, the first SL transmission, or the first DL reception is overlapped in time domain with a first resource, within the set of resources, for performing a first R2D transmission, prioritizing to perform either the first UL transmission, the first SL transmission, or the first DL reception or the first R2D transmission based on a type of the first UL transmission, the first SL transmission, or the first DL reception; and/or
when the first UL transmission, the first SL transmission, or the first DL reception is overlapped in time domain with a second resource, within the set of resources, for receiving a second D2R transmission, prioritizing to perform either the first UL transmission, the first SL transmission, or the first DL reception or receiving the second D2R transmission based on the type of the first UL transmission, the first SL transmission, or the first DL reception.

17. The method of claim 12, further comprising:
being scheduled, requested, or configured to perform a first Uplink (UL) transmission, a first Sidelink (SL) transmission, or a first Downlink (DL) reception;
if the first UL transmission, the first SL transmission, or the first DL reception is overlapped in time domain with the set of resources, the UE is required to prioritize the first UL transmission, the first SL transmission, or the first DL reception; and/or
if the first UL transmission, the first SL transmission, or the first DL reception is overlapped in time domain with the set of resources, the UE is required to perform the first UL transmission, the first SL transmission, or the first DL reception, and the UE is required to skip, drop, or suspend any R2D transmission or any D2R reception, if any, during the first UL transmission, the first SL transmission, or the first DL reception.
